(19) United States
(12) Patent Application Publication
(10) Pub. No.: US 2024/0392072 A1
(43) Pub. Date: Nov. 28, 2024

(54) METHOD FOR PREPARING LOW-SILANOL POLYORGANOSILOXANES

(71) Applicant: WACKER CHEMIE AG, Munich (DE)

(72) Inventors: Frank SANDMEYER, Burgkirchen (DE); Claudia Katharina HAHN, Mettenheim (DE)

(73) Assignee: Wacker Chemie AG, Munich (DE)

(21) Appl. No.: 18/695,987

(22) PCT Filed: Sep. 29, 2021
(86) PCT No.: PCT/EP2021/076881

§ 371 Date: Mar. 27, 2024

(51) Int. Cl. C08G 77/06; C08J 3/24

(52) U.S. Cl. CPC C08G 77/06; C08J 3/24

(57) ABSTRACT

A process for preparing polyorganosiloxanes and uses for the same. Where the polyorganosiloxanes produced are low-silanol polyorganosiloxanes.

The present invention relates to a process for preparing polyorganosiloxanes which ensures that polar Si—O—C-bonded groups and silanol groups are reduced to a minimum and accordingly the polyorganosiloxanes have dielectric properties suitable for radiofrequency applications.

### PRIOR ART

With the progressive opening of the radiofrequency technology for wireless communication, there is rise in the demand for materials capable of realising this technology. This concerns all sectors of materials such as copper foils, binders, glass fibres, etc. In the case of the binders, the epoxy resins used conventionally for producing copper-faced laminates and subsequently for circuit board production can no longer be employed, because their dielectric loss factors are too high. Polytetrafluoroethylene, which possesses a very low dielectric loss factor and on that basis is very useful for radiofrequency applications, possesses other disadvantages, particularly the poor processing properties and poor adhesion properties, which make an alternative desirable. Polyphenylene ethers are presently utilized intensively as binders for this field of application, as they combine low dielectric loss factors with good mechanical and thermal properties and water repellency. In addition, presently, other organic polymers as well are being considered in the current development activities for this field of application, examples being bismaleimide polymers, bismaleimide-triazine copolymers and hydrocarbon resins, and this listing could be supplemented with further examples.

Polyorganosiloxanes possess fundamentally excellent heat resistance, weathering stability and hydrophobicity, are flame-retardant, and possess low dielectric loss factors.

These profiles of properties qualify not only the stated organic polymers but also the polyorganosiloxanes for use as binders for the production of radiofrequency-compatible, copper-faced laminates and components, such as circuit boards and antennas. It is therefore obvious to combine the positive properties of these classes of materials, in order to achieve a symbiotic increase in their performance capacity. Experiments in this direction have already been documented in the prior art.

Polar substituents in the polyorganosiloxanes are unwanted in this context, as they push up the dielectric loss factor. According to the prior art, polyorganosiloxanes are prepared preferably by a process of hydrolytic condensation. Alcohols as well may be used in such a process. In this regard, see for example:

### PRIOR ART

Combinations of polyorganosiloxanes and polyphenylene ethers for improving the flame retardancy are described in U.S. Pat. No. 6,258,881. Especially suitable for this purpose are solid polyorganosiloxanes having a defined particle size.

Further examples of the use of compositions made up of physical mixtures of polyphenylene ethers with polyorganosiloxanes for the purpose of improving specific properties are found in U.S. Pat. No. 3,737,479 (improvement in impact strength), U.S. Pat. No. 5,834,585 (mixtures of chemically curable polyphenylene ethers with improved processing properties), US 2004/0138355 (improvement in flame retardancy through blends with closed and partially opened silsesquioxane cage structures), U.S. Pat. No. 3,960,985 (improvement in the thermal stability of mixtures of polyphenylene ethers with alkenylaromatic polymers by addition of small amounts of polydimethylsiloxanes having in-chain Si—H functionality).

These examples are evidence of the interest and fundamental usefulness of polyorganosiloxanes as additives and cobinders for radiofrequency applications.

US 2016/0244610 describes compositions made up of mixtures of olefinically unsaturated MQ resins with polyphenylene ethers modified for unsaturation, the purpose of using the MQ resin being to improve the dielectric and the thermal properties of the polyphenylene ethers. However, the examples in US 2016/0244610 exhibit decidedly high dielectric loss factors for the compositions of that invention. Since, in explaining the technological environment, US 2016/0244610 makes particular reference to the future development of communications technology, the invention must be considered and evaluated in relation to the requirements of that environment.

Regarding the requirement and performance capacity already achieved by present-day materials with suitability for use for 5G applications, reference may be made to US 2020/369855. In US 2016/0244610 it is observed, and also claimed, that the polyorganosiloxanes of that invention are prepared by a hydrolytic process from the monomers. That process additionally uses alcohol as solvent and alkoxylated precursors as reagents.

In light of the failure of US 2016/0244610 to provide an analytical description of the MQ resins obtained, reference may be made at this point to U.S. Pat. No. 5,548,053, as a more readily comprehensible prior art, which describes the synthesis of MQ resins in a hydrolytic process. The special feature of the process of U.S. Pat. No. 5,548,053 is that the MQ resins are prepared in a two-stage process, with reduction in the number of residual silanol groups in the second step. The procedure otherwise is comparable in principle to the procedure in the examples of US 2016/0244610.

Since US 2016/0244610 does not employ the second stage of the process of U.S. Pat. No. 5,548,053, there is also no likelihood of the silanol group reduction effect as achieved in U.S. Pat. No. 5,548,053 in the case of US 2016/0244610. In US 2016/0244610, therefore, the assumption must be that of a higher number of silanol groups than is indicated in U.S. Pat. No. 5,548,053. In spite of the targeted reduction in the silanol groups by the process of the invention from U.S. Pat. No. 5,548,053, there remains substantial amounts of alkoxy groups, which are likewise Si—O—C-bonded polar groups and oppose the attainment of a low dielectric loss factor. Since U.S. Pat. No. 5,548,053 in terms of the synthesis of the MQ resins represents a prior art which, while being earlier, is nevertheless more superior for the purpose of reduction in polar groups, the MQ resins of US 2016/0244610 possess poorer properties for use in radiofrequency applications, in terms of the number of silicon-bonded polar groups, than those obtainable according to U.S. Pat. No. 5,548,053. The fact that the examples of US 2016/0244610 do not go back to the U.S. Pat. No. 5,548,053 prior art already in existence is incomprehensible in this context. As maintained, however, in this case as well, there would be a substantial quantity of alkoxy groups remaining in the resin as well as residual amounts of silanol groups.

A further weakness of the teaching of US 2016/0244610 is the unsatisfactory outcome of the compositions of the invention in the application results because of the incompatibility of the MQ resins used in the polyphenylene ether matrix. This circumstance is clearly recognised and is documented in the examples and so the problem-solving nature of the invention in US 2016/0244610 is not apparent, and consequently US 2016/0244610 misses its target and provides neither teaching nor benefit of the presented combinations for the sector of wireless radiofrequency communications technology.

What US 2016/0244610 does show, however, is the fact that homogeneous physical compositions of silicones, in this case silicone resins of the MQ resin type, with polyphenylene ethers are not readily possible. The selection especially of suitable silicone resins which are compatible, have good processing properties and are available in a suitable presentation form, and which allow a synergistic reinforcement of the positive properties both of the organic component of the polyphenylene ether and the silicone component, poses a particular challenge. In the interest of an optimal outcome, it is then necessary, in addition, to prepare the inventively useful polyorganosiloxanes by suitable processes which reduce polar groups to a minimum. A process of this kind can be found neither in US 2016/0244610 nor in U.S. Pat. No. 5,548,053.

In the same way as US 2016/0244610, US 2018/0220530 as well describes compositions made up of mixtures of silicone resins, in this case of types MT, MDT, MDQ and MTQ, which are claimed in a wholesale way and as classes, without closer restriction. The silicone resins claimed are all prepared by a hydrolytic process.

In the same way as US 2016/0244610 and US 2018/0220530, US 2018/0215971 teaches compositions made up of mixtures of silicone resins, in this case of types TT and TQ, which in this case as well are claimed in a wholesale way and as classes, without closer restriction, with vinyl-functional or (meth)acrylate-functional polyphenylene ethers, it being claimed that all the silicone resins of the invention are prepared by a hydrolytic process from the starting monomers.

US 2018/0215971 and US 2018/0220530 again do not provide any analytical data but might indicate to what extent Si—O—C-bonded polar groups and silanol groups are retained in the synthesis process employed.

The dielectric loss factors aimed at in both inventions are <0.007. This requirement is achieved with freshly produced specimens of the materials of the invention, albeit without significant undershooting, and so the prior art of US 2018/0215971 and US 2018/0220530 leaves significant space available for improvements.

Measured in terms of the dielectric loss factors of the solutions of the invention according to US 2018/0215971 and US 2018/0220530, it is noteworthy that the compositions of US 2018/0215971 and US 2018/0220530 are significantly more expensive than solutions already available in the prior art that achieve comparable dielectric loss factors at substantially better economy. These inventions as well therefore lack a teaching which constitutes an onward development of the prior art, and any realisation of the inventions of US 2016/0244610, US 2018/0215971 and US 2018/0220530 appears unlikely.

An alternative to a hydrolytic preparation process for the synthesis of polyorganosiloxanes is taught by US 2019359774. In this case alkali metal siliconates, obtainable from the reaction of organosilanols or alkoxy-functional silane or siloxane precursors with alkali metal hydroxides, are reacted with chlorosilyl components in an anhydrous condensation process. The alkali metal siliconates reacted in the process of the invention there are prepared in a separate upstream synthesis step. The process uses an auxiliary base in order to bind the hydrogen chloride formed during the reaction. Salt is removed by filtration or as an aqueous solution in the work-up with water. Silanol-free and alkoxy-free linear polyorganosiloxanes are obtained in this way.

The possibility of applying the synthesis to silanol-functional polyorganosiloxanes without the diversion route entailing the alkali metal siliconates is not shown. The synthesis, moreover, remains limited to linear polyorganosiloxanes.

### Stated Object

The present invention is dedicated to the object of providing crosslinkable polyorganosiloxanes having dielectric properties suitable for use as binders for radiofrequency applications, in a water-free process, such that they are obtained economically, in particular without the diversion route entailing metal siliconates or other raw materials needing to be produced in a separate step, having a minimum of Si—O—C-bonded polar groups and in a structural diversity which is sufficient for the use, including in particular with three-dimensional structure. Part of this requirement is that as pure binder, the polyorganosiloxanes possess a dielectric loss factor at 10 GHz of not more than 0.0040, provide effective wetting of any fillers present that lower the dielectric loss factor, allow the production of tack-free prepregs, and give preparations which are compatible with organic polymers.

A subject of the invention is a process for preparing polyorganosiloxanes of the formula (I)

[O_{3-a/2}RₐSiY(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g}[O_{3-h/2}R⁴ₕSi(SiR⁵₂)ᵢSiR⁴ⱼO_{3-j/2}]ₖ(I)
where the radicals R may be identical or different radicals and are either a hydrogen radical or a monovalent, Si—C-bonded unsubstituted or heteroatom-substituted organic hydrocarbon radical having 1 to 18 carbon atoms, which may also be an unsaturated hydrocarbon radical,
Y is a chemical bond, an oxygen atom or a di- to dodecavalent organic unsubstituted or heteroatom-substituted organic radical having 1 to 24 carbon atoms and bonded to the silicon atoms by Si—C linkage,
the radicals R¹, R² and R³ independently of one another are a hydrogen radical or a saturated or unsaturated, Si—C-bonded C1-C18 hydrocarbon radical, which may be unsubstituted or substituted by heteroatoms, or are a C1-C12 hydrocarbon radical which is bonded via an oxygen atom and may contain heteroatoms, or are a silanol radical, where the radicals R¹, R² and R³ may adopt their definition in each case independently of one another, and so two or more radicals R¹, R² and/or R³ bonded on the same silicon atom may be different radicals from the group defined,
the radicals R⁴ independently of one another are either a hydrogen radical, a silanol radical or a monovalent, Si—C— or Si—O—C-bonded, unsubstituted or heteroatom-substituted organic hydrocarbon radical having 1 to 18 carbon atoms, which may also be an unsaturated hydrocarbon radical,
the radicals R⁵ independently of one another either are a hydrogen radical, a monovalent, Si—C-bonded, unsubstituted or heteroatom-substituted organic hydrocarbon radical having 1 to 18 carbon atoms, which may also be an unsaturated hydrocarbon radical, or are a radical of the formula (II)

[O_{3-a/2}RₐSiY(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g} (II),
where, based on all the radicals Y, R, R¹, R², R³, R⁴ and R⁵ as 100 mol %, at least 0.1 mol %, preferably at least 3 mol %, more preferably at least 5 mol %, more particularly at least 7 mol % must be olefinically or acetylenically unsaturated radicals, based on all the radicals Y, R, R¹, R², R³, R⁴ and R⁵ as 100 weight %, in total at most 3 wt %, preferably at most 2.5 wt %, more particularly at most 2 wt % are Si—O—C-bonded radicals and silanol radicals,
and, based on all the radicals Y, R, R¹, R², R³, R⁴ and R⁵ as 100 weight %, in total at most 0.5 wt %, preferably at most 0.2 wt %, more particularly at most 0.1 wt % are silanol radicals,
a is 0, 1 or 2, where the indices a on both sides of the group Y may adopt their definition independently of one another, and so different a independently of one another may have different values within the specified value range,
b is a number with a value of 1 to 11, preferably 1,
c has a value of 0 to 0.9,
d has a value of 0 to 0.8,
e has a value of 0 to 0.5,
f has a value of 0.01 to 0.6,
g has a value of 0 to 0.6,
h and j independently of one another are 0, 1 or 2,
i is an integer with a value of 0 to 50 and
k has a value of 0 to 0.9, where
c+d+e+f+g+k=1, at least one value c, d or k is >0 and e+g is ≤0.6, preferably <0.5, more particularly <0.4,
where the radicals R, R¹, R², R³, R⁴ and R⁵ and the indices a, b, c, d, e, f, g, h and i in formula (I) and in formula (II) independently of one another may have the same definitions and may adopt these definitions independently of one another within the value ranges described,
by reacting, in a first step, silanes of the formula (III)

R⁶ₗSiR⁷₄₋ₗ (III),
where R⁷ is a hydrolysable group,
l is an integer with a value of 0, 1 or 2 and
R⁶ if l=1 is a radical R¹ and if l=2 is a radical R²,
and/or di-, oligo- or polysilanes of the formula (IV)

R⁷₃₋ₕR⁴ₕSi(SiR⁵₂)ᵢSiR⁴ⱼR⁷₃₋ⱼ (IV),
where R⁷ as described above is a hydrolysable group and
R⁴, R⁵, h, i and j have the same definitions as stated above,
and/or organyl-bridged silicones of the formula (V)

R⁷₃₋ₐRₐSiY(SiRₐR⁷₃₋ₐ)_{b} (V),
where R⁷, R, Y, a and b have the definition already stated,
with water and, if at least one of the hydrolysable radicals R⁷ is not a halogen radical, using catalytic amounts of one or more acids which promote the hydrolysis and condensation of the components of formulae (III), (IV) and (V), in the presence of a non-water-miscible, aprotic solvent, which in particular is not an alcohol and also contains no alcohol,
where, after reaction has taken place, both the water and the remaining amount of acid in the organic phase are reduced to the technically related minimum, more particularly to less than 10 000 ppm each, preferably less than 5000 ppm each, more particularly less than 2000 ppm each, so that they are present, if at all, only as an unwanted impurity, and
in a second step reacting the reaction product from the first step, in solution in the inert organic solvent, without water, with a halosilane of the formula (VI)

R³₃SiR⁸ (VI),
where R³ has the same definitions as indicated above and R⁸ is a halogen atom, preferably a chlorine atom,
in the presence of an auxiliary base, where auxiliary bases used are preferably basic metal salts and nitrogen compounds.

Surprisingly it has been found that the stated object is achieved by the process for preparing the polyorganosiloxanes of the formula (I) that consists of two steps, where the first step represents a hydrolytic condensation and in the second step the silanol groups present from the first step are reduced by an anhydrous condensation, so that the polyorganosiloxane compositions are obtained without the use of metal siliconate intermediates and in a non-hydrolytic process.

The polyorganosiloxanes of the formula (I) obtained according to the process of the invention are notable in that they are largely free from silanol groups and from silicon-bonded alkoxy groups.

Alkoxy groups, in particular with short alkyl groups, and silanol groups lead to higher dielectric loss factors and contribute, furthermore, to an increase in the dielectric loss factor, by forming points of attack for moisture.

Polyorganosiloxanes of the formula (I) in the context of the present invention encompass both polymeric and oligomeric organosiloxanes.

The structures comprised include in particular those of the formulae (la), (Ib) and (Ic),

[O_{3-a/2}RₐSiY(SiRₐO_{3-a/2})_{b}]_{c}(R³₃SiO_{1/2})_{f} (Ia),

(R³₃SiO_{1/2})_{f}[O_{3-h/2}R⁴ₕSi(SiR⁵₂)ᵢSiR⁴ⱼO_{3-j/2}]ₖ (Ib)

[O_{3-a/2}RₐSiY(SiRₐO_{3-a/2})_{b}]_{c}(R³₃SiO_{1/2})_{f}[O_{3-h/2}R⁴ₕSi(SiR⁵₂)ᵢSiR⁴ⱼO_{3-j/2}]ₖ (Ic)
where in (Ia) d, e, g and k are each 0, in (Ib) c, d, e and g are each 0 and in (Ic) d, e and g are each 0. In these structures the fraction of Si—O units is reduced the most in favour of Si—C and Si—Si units.

Since the electronegativity difference between silicon and oxygen according to the electronegativity scale of Allred and Rochow, at 1.76, is greater by 1 than the electronegativity difference between silicon and carbon according to the same table, the Si—C bond possesses a lower polarity than the Si—O bond. It is therefore to be expected that the replacement of Si—O bonds with Si—C bonds makes a further contribution to reducing the overall polarity of organopolysiloxanes and hence a contribution to reducing the dielectric loss factor of corresponding components. The greater the number of Si—O bonds that can be replaced with Si—C or Si—Si bonds, the more pronounced this effect. The reduction of the polarity in the organopolysiloxane framework from the introduction, for example, of Si—C or Si—Si bonds rather than Si—O bonds therefore makes a considerable contribution to the broad usefulness of such organopolysiloxanes and is the most preferred embodiment of the invention.

Because the units of the form (R³₃SiO_{1/2}) are used in the anhydrous second step for the purpose of reducing the silanol groups that have remained after the hydrolysis, these groups are always present. In the nomenclature which classifies silicone building blocks according to M, D, T and Q units, depending on the number of oxygen atoms by which a silicon atom is bonded to further silicon atoms, and whereby an M unit correspondingly is a unit of the formula R₃SiO_{1/2}, correspondingly a D unit possesses the formula R₂SiO_{2/2}, a T unit the formula R₁SiO_{3/2} and a Q unit the formula SiO_{4/2}, the polyorganosiloxanes of the invention are therefore, in the broadest sense, combinations of T, D and Q units with M units, and hence are M, MD, MT, MDT, MDTQ, MTQ and MDQ resins, with no distinction being made here between M, D and T units having different compositions. An M resin consisting of different M units is to be understood from formula (Ia) if a value of 2 is assumed for all the a and Y is either a chemical bond or an Si—C-bonded bridging radical. In that case each silicon atom in the bridged unit is surrounded by only one oxygen atom, which maintains a bond to an adjacent silicon atom and can therefore be understood, in the sense of the general M, D, T, Q nomenclature, to be an M₂ building block in which two M units are bonded to one another or coupled to one another through a bridging radical. This structural peculiarity of chain-forming M units made up both of the organically bridged units and of the di-, oligo- and/or polysilane units must be taken into account in this case.

Simple M units of the kind corresponding to the synthesis equivalents for the units of the formula (R₃SiO_{1/2})_{f} and as used in US 20180220530 are not used in the first step of the synthesis, the hydrolytic reaction step. While this is possible in principle, it does not provide the same effect, for the reduction of the silanol groups, as the use of these groups in the second, anhydrous synthesis step. The units of the formula (R₃SiO_{1/2})_{f} are therefore used only in the second, anhydrous reaction step in order to reduce the number of the silanol groups and so to achieve an improvement relative to the prior art according to US 20180220530. This is a key distinguishing feature of the procedure according to the invention. In US 20180220530, all of the building blocks forming the polyorganosiloxanes of that invention are reacted with one another in only one hydrolytic step, there being no possibility in that case to achieve a further reduction in the silanol groups formed in the condensation and of consequently improving the binders further for the target application as binders for radiofrequency applications. No attention whatsoever is paid in US 20180220530 to the fact that, after a hydrolytic condensation, there are inadvertently silanol groups present that are bound on the polyorganosiloxane framework, and this lack of attention is readily apparent from the fact that there is absolutely no meaningful analytical description in this regard of the polyorganosiloxanes of the invention there. Evidently the inventors did not realize the significance of the precise composition of the polyorganosiloxanes according to US 20180220530 and the structure-activity relationships explainable as a result and starting points for improvements, if they consider them to be so immaterial that they do not disclose them as relevant to the invention.

Since there is also no adoption of the possibility of using Si—Si-bonded or Si—C-bridged units in order to reduce the fraction of polar bonds in the polyorganosiloxane framework, the present invention produces a further improvement relative to the prior art according to US 20180220530.

In the structures (la), (Ib) and (Ic), the fraction of Si—C-bonded bridging organic radicals, and/or Si—Si bonds, which are of course likewise apolar, is particularly high, and the structure is closed off virtually only by the terminating units (R³₃SiO_{1/2})_{f}.

Examples of R, R¹, R², R³, R⁴ and radicals R⁵ except for the radicals R⁵ which are radicals of the formula (II) are saturated or unsaturated hydrocarbon radicals which may contain aromatic or aliphatic double bonds, examples being alkyl radicals, such as the methyl, ethyl, n-propyl, isopropyl, n-butyl, isobutyl, tert-butyl, n-pentyl, isopentyl, neopentyl and the tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl and the 2-ethylhexyl radical, nonyl radicals, such as the n-nonyl radical, decyl radicals, such as the n-decyl radical, dodecyl radicals, such as the n-dodecyl radical, tetradecyl radicals, such as the n-tetradecyl radical, hexadecyl radicals, such as the n-hexadecyl radical and octadecyl radicals, such as the n-octadecyl radical, cycloalkyl radicals, such as cyclopentyl, cyclohexyl and 4-ethylcyclohexyl radical, cycloheptyl radicals, norbornyl radicals and methylcyclohexyl radicals, aryl radicals, such as the phenyl, biphenylyl, naphthyl and anthryl and phenanthryl radical; alkaryl radicals, such as o-, m-, p-tolyl radicals, xylyl radicals and ethylphenyl radicals; aralkyl radicals, such as the benzyl radical, alkenyl radicals, such as the 7-octenyl, 5-hexenyl, 3-butenyl, allyl and the vinyl radical, and also the alpha- and the ß-phenylethyl radical.

Preferred heteroatoms which may be present in the radicals R, R¹, R², R³, R⁴ and R⁵ are oxygen atoms. Also possible, furthermore, though not preferred, are nitrogen atoms, phosphorus atoms, sulfur atoms and halogen atoms such as chlorine atoms and fluorine atoms.

Examples of preferred heteroatom-containing organic radicals R, R¹, R², R³, R⁴ and R⁵ are radicals which contain acryloyloxy and methacryloyloxy radicals from acrylic acid or methacrylic acid respectively and also acrylic esters or methacrylic esters of unbranched or branched alcohols having 1 to 15 carbon atoms. Preferred such radicals are those deriving from methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate. Particularly preferred are methyl acrylate, methyl methacrylate, n-butyl acrylate, isobutyl acrylate, t-butyl acrylate, 2-ethylhexyl acrylate, and norbornyl acrylate.

These radicals are preferably not bonded directly to the silicon atom, but instead are bonded via a hydrocarbon spacer which may comprise 1 to 12 carbon atoms, and preferably comprises 1 or 3 carbon atoms and comprises no heteroatoms other than the heteroatoms present in the acryloyloxy or methacryloyloxy radical. The radicals R, R¹, R², R³, R⁴ and R⁵ are preferably selected from methyl, phenyl, vinyl, acryloyloxy and methacryloyloxy radicals and also the acrylic esters or methacrylic esters of unbranched or branched alcohols having 1 to 15 carbon atoms.

Further preferred heteroatom-comprising radicals R, R¹, R² and R³ are those of the formula (VII).

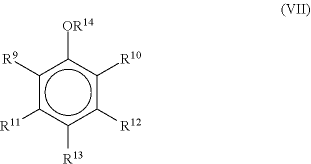

In formula (VII) R⁹, R¹⁰, R¹¹, R¹², R¹³ and R¹⁴ independently of one another are a hydrogen radical, a hydrocarbon group, or a hydrocarbon group substituted by foreign atoms, where always at least one of the radicals R⁹, R¹⁰, R¹¹, R¹², R¹³ and R¹⁴ is a hydrocarbon group which is bonded via an Si—C or Si—O—C bond to the silicon atom, it being preferred for this hydrocarbon group via which the radical of the formula (VII) is bonded to a silicon atom to be a C3 hydrocarbon group which contains no heteroatoms. Alternatively the radical R⁹, R¹⁰, R¹¹, R¹², R¹³ and R¹⁴ may also be a chemical bond, and so the radical of the formula (II) is bonded directly to the silicon atom via an Si—C bond by way of this radical which represents a chemical bond.

Examples of radicals R⁹, R¹⁰, R¹¹, R¹², R¹³ and R¹⁴ are the hydrogen radical, saturated hydrocarbon radicals such as the methyl, ethyl, n-propyl, isopropyl, the primary, secondary and tertiary butyl radical, the hydroxyethyl radical, aromatic radicals such as the phenylethyl radical, the phenyl radical, the benzyl radical, the methylphenyl radical, the dimethylphenyl radical, the ethylphenyl radical, heteroatom-containing radicals such as the hydroxymethyl radical, the carboxyethyl radical, the methoxycarbonylethyl radical, and the cyanoethyl radical, and acrylate and methacrylate radicals, such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate, and olefinically or acetylenically unsaturated hydrocarbon radicals.

The adjacent radicals R⁹ and R¹¹ and also the adjacent radicals R¹⁰ and R¹² may optionally also be joined with one another to the same cyclic saturated or unsaturated radical, and so fused polycyclic structures may be formed.

Examples of phenol radicals of the formula (VII) are the phenol radical, the ortho-, meta- or para-cresol radical, 2,6-, 2,5-, 2,4- or 3,5-dimethylphenol radical, 2-methyl-6-phenylphenol radical, 2,6-diphenylphenol radical, 2,6-diethylphenol radical, 2-methyl-6-ethylphenol radical, 2,3,5-, 2,3,6- or 2,4,6-trimethylphenol radical, 3-methyl-6-tert-butylphenol radical, thymol radical and 2-methyl-6-allylphenol radical, which may optionally be substituted on the oxygen atom.

Preferred examples of fluorine-containing radicals are the trifluoropropyl, the nonafluorohexyl and the heptadecafluorooctyl radical.

Y is preferably a connecting organic unit having 1 to 24 carbon atoms between two to twelve siloxanyl units. Y is preferably di-, tri- or tetravalent, more particularly divalent.

Preferred bridging aromatic radicals Y are those of the formulae (VIIIa), (VIIIb) and (VIIIc)

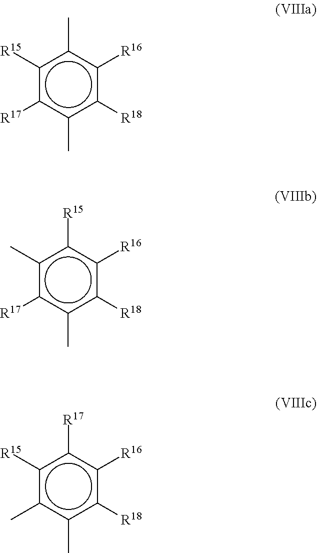

where the radicals R¹⁵, R¹⁶, R¹⁷ and R¹⁸ may be a hydrogen radical, or an optionally substituted hydrocarbon radical or a group of the formula OR¹⁹ where R¹⁹ is a hydrocarbon radical. Adjacent radicals here such as R¹⁵ and R¹⁷ or R¹⁶ and R¹⁸ in formula (VIIIa), for example, may be coupled to one another to form cyclic radicals, and so fused ring systems are formed.

Typical examples of such bridging aromatic radicals are the p-, m- or o-phenylene radical, the 2-methyl-1,4-phenylene radical, the 2-methoxy-1,4-phenylene radical, with the p-phenylene radical being particularly preferred.

It is also possible for two or more such radicals to be coupled to one another, so that, for example, two or more units of the formula (IIIa) are coupled to one another and this oligomeric bridging structural element is present on silicon atom by attachment of the corresponding carbon atoms of the terminal aromatic rings. The aromatic units here may be bonded to one another directly or they may be coupled to one another through a bridging group such as an alkanediyl unit, such as, for example, the methylene group, the 1,2-ethanediyl group, 1,1-ethanediyl group, the 2,2-dimethylpropyl group, or a sulfone group.

Further examples of aromatic bridging units are those in which two optionally substituted phenol rings are bridged via an alkanediyl unit or other units. Typical representatives are the following radicals with substitution on the phenol oxygen: 2,2-bis(4-hydroxyphenyl)propane radicals (substituted bisphenol A radicals), 2,2-bis(4-hydroxyphenyl)methane radicals (substituted bisphenol F radicals) and bis(4-hydroxyphenyl)sulfone radicals (bisphenol S radicals), with the phenol oxygen atoms being substituted typically by radicals of the —(C₃H₆)— type, in which case the radicals —(C₃H₆)— are Si—C bonded to silicon atoms, thereby producing the bridging.

Preferred radicals Y not bridged by an aromatic unit are alkanediyl, alkenediyl and alkynediyl radicals, which may optionally contain heteroatoms and which may contain aromatic groups as substituents which, however, in these radicals do not take on or contribute to the function of bridging.

Typical examples are the methylene radical, the methine radical, the tetravalent carbon, the 1,1-ethanediyl and the 1,2-ethanediyl group, the 1,4-butanediyl and the 1,3-butanediyl group, the 1,5-pentanediyl, 1,6-hexanediyl, 1,7-heptanediyl, 1,8-octanediyl, 1,9-nonanediyl, 1,10-decanediyl, 1,11-undecanediyl and the 1,12-dodecanediyl group, the 1,2-diphenylethanediyl group, the 1,2-phenylethanediyl group and the 1,2-cyclohexylethanediyl group. Where a linear bridging unit possesses more than one carbon atom and the substitution pattern allows it, each of these groups may bring about bridging through the alpha-omega connectivity, in other words the bridging through the first and last respective atoms of a linear unit by any other connectivity as well, in other words the use of different chain carbon atoms. Typical examples, moreover, are not only the linear representatives of the stated bridging hydrocarbons, but also their isomers, which in turn may produce bridging by attachment of different carbon atoms of the hydrocarbon structure to silicon atoms. Examples of especially preferred radicals from the group of the non-aromatic, heteroatom-free hydrocarbon radicals are —CH₂CH₂—, —CH(CH₃)—, —CH═CH—, —C(═CH₂)— and —C≡C—.

Examples of typical fluorine-substituted bridging radicals Y are the —C(CF₃)₂—, the —C(H)F—C(H)F— and the —C(F₂)—C(F₂)— radical.

Examples of typical heteroatom-containing bridging radicals are, for example, the ethyleneoxypropylene radical and the ethyleneoxybutylene radical. Other typical examples are phenylene ether radicals or glycol radicals with bilateral —(CH₂)ₙ— or —CH₂—CH(R¹⁵)—C(═O)O-termination, where n is typically 3 to 8 and R¹⁵ is a hydrogen atom or a methyl group, which are bonded to the silicon atoms via this terminal group.

All recitations should be understood as being merely illustrative and not limiting.

In terms of their viscosity the organopolysiloxanes used in the invention may vary over a wide range or else be solids, depending on the average number of their constituent structural units per molecule.

Liquid organopolysiloxanes useful in the invention in the non-crosslinked state at 25° C. possess viscosities of 20 to 8 000 000 mPas, preferably of 20 to 5 000 000 mPas, more particularly of 20 to 3 000 000 mPas.

Solid organopolysiloxanes useful in the invention in the non-crosslinked state possess glass transition temperatures in the range from 25° C. to 250° C., preferably from 30° C. to 230° C., more particularly from 30° C. to 200° C. Organopolysiloxanes having proven particularly suitable are those which possess bridging phenylene units and which in total possess an aromatic fraction of at least 20 mol %, based on all the Si—C-bonded substituents as 100 mol %. Phenylene units here are understood to be both monomeric and oligomeric and substituted and also unsubstituted phenylene units, as described illustratively in the examples for the nature of the bridging substituents of this type.

Selected examples of radicals R⁵ of the formula (II) are linear and cyclic structures with the average composition

[O_{2/2}MeSi—CH₂—CH₂—SiMeO_{2/2}][(CH₂=CH)(Me)₂SiO_{1/2}]₃,

[O_{2/2}MeSi—CH₂—CH₂—SiMeO_{2/2}][(H)(Me)₂SiO_{1/2}]₃,

[O_{2/2}MeSi—CH₂—CH₂—SiMeO_{2/2}]₂[(CH₂=CH)(Me)₂SiO_{1/2}]₅,

[O_{2/2}MeSi—CH₂—CH₂—SiMeO_{2/2}]₂[(H)(Me)₂SiO_{1/2}]₅,

[O_{2/2}PhSi—C₆H₄—SiPhO_{2/2}][(CH₂=CH)(Me)₂SiO_{1/2}]₃,

[O_{2/2}PhSi—C₆H₄—SiPhO_{2/2}][(H)(Me)₂SiO_{1/2}]₃,

[O_{2/2}PhSi—C₆H₄—SiPhO_{2/2}]₂[(CH₂=CH)(Me)₂SiO_{1/2}]₅,

[O_{2/2}PhSi—C₆H₄—SiPhO_{2/2}]₂[(H)(Me)₂SiO_{1/2}]₅,

[O_{2/2}MeSi—C₆H₄—SiMeO_{2/2}][(CH₂=CH)(Me)₂SiO_{1/2}]₃,

[O_{2/2}MeSi—C₆H₄—SiMeO_{2/2}][(H)(Me)₂SiO_{1/2}]₃,

[O_{2/2}MeSi—CH₂—CH₂—SiMe₂O_{1/2}]₈[(CH₂=CH)(Me)₂SiO_{1/2}]₉,

[O_{2/2}MeSi—CH₂—CH₂—SiMeO_{2/2}]₈[(CH₂=CH)(Me)₂SiO_{1/2}]₈[(H)(Me)₂SiO_{1/2}]₉,

(CH₂=CH)(Me)₂SiO_{1/2},

(H)(Me)₂SiO_{1/2},

(CH₃—CH(═CH₂)C(═O)O—CH₂CH₂CH₂)(Me)₂SiO_{1/2},

(Me)₃SiO_{1/2},

(CH₂=CH)₃SiO_{1/2},

(CH₂=CH)Ph₂SiO_{1/2}.

Examples of preferred hydrolysable radicals R⁷ and R⁸ are a halogen, acid or alkoxy group, more preferably a chlorine, acetate, formate, methoxy or ethoxy group.

The compounds (VI) are obtained by prior-art processes, with the types of reaction to be used depending greatly on the composition of the respective compound (VI). Compounds (VI) are obtained typically, for example, from olefinically unsaturated organic precursors, such as, for example, acetylene, diallyl or divinyl compounds and Si—H-functional silicone building blocks, by hydrosilylation.

Conceivable processes here also include Grignard reactions from halogenated organic precursors and subsequent reaction with halogenated or alkoxylated organosilanes. It is optionally also possible to use metal halide exchange reactions of halogenated organic precursors with alkyl alkali metal compounds, such as butyllithium, for instance, and known follow-on reactions for the linkage to silicone building blocks. The skilled person is aware of such processes, which are readily accessible and comprehensible from the available literature. Since these processes are not subjects of the invention, reference is merely made at this point to the documented and searchable prior art.

The first process step, the cohydrolysis, is preferably performed by metering a mixture of the compounds (III), (IV), (V) and (VI), in so far as they are used, into water or dilute acids with cooling. In the case of gaseous acids such as HCl, metering into a concentrated aqueous HCl solution is likewise sensible, if the acid liberated is to be recovered as a gas. Depending on the nature of the hydrolysable groups R⁷, the hydrolysis is exothermic to a greater or lesser extent, and so cooling is necessary both in the interest of the safe performance of the reactions and where appropriate in order to avoid secondary reactions in corresponding sequences of the syntheses. In order to complete the reactions, conversely, it may be advantageous and necessary to employ elevated temperatures.

The reaction times in the case of chlorosilanes are generally very short, and so the time required to carry out the process in batch operation depends principally on the cooling performance. Alternatively the cohydrolysis of (III), (IV) and/or (V) may also be carried out continuously, for which not only loop reactors but also column reactors and tube reactors are appropriate.

In order to deplete residual acids, effective washing with water, clean phase separation and purification of the hydrolysis product under reduced pressure are advantageous.

The process may be carried out under atmospheric pressure. Depending on the objective, however, higher or lower pressure is likewise practical. It is essential that at the end of the first process step, the amount of water present is reduced to an extent such that at most there are still residual quantities of water present which can no longer be depleted further by prior-art methods, as an unintended impurity. Ideally the amount of residual water remaining is reduced such that it is below the detection limit, and so an anhydrous medium can be assumed. This depletion of water is necessary for the successful implementation of the process of the invention, since water is accompanied fundamentally by the option for formation of silanol groups, if conditions exist under which polyorganosiloxanes are able to react with water—that is, typically, acidic or basic conditions. Since the intention is to deplete silanol groups, the presence of water in the next step is detrimental. In the rest of the text, the reaction mixture from the first step that is depleted of water is referred to as anhydrous.

The second process step is performed with the water-freed reaction mixture from the first step. The silanol groups on the polyorganosiloxane from the first step are reacted with silanes of the formula (VI) by metering them in, where appropriate as a solution in an inert solvent. In order to start the reaction and to accelerate it an auxiliary base is advantageously used. In principle the reaction between the silanol groups and the silanes of the formula (VI) is possible even without auxiliary base, but in that case the reaction rate is so low that the reaction would be uneconomic on the industrial scale, owing to the long reaction time, or would lead to inadequate conversions. The radical R⁸ is a halogen radical, more particularly a chloride radical.

Suitability as auxiliary base for scavenging the hydrogen halide formed is possessed by basic salts or nitrogen-containing compounds such as amines, ureas, imines, guanidines and amides. Examples of basic salts are sodium hydride, sodium amide, sodium carbonate, sodium hydrogencarbonate, potassium carbonate, potassium hydrogencarbonate, calcium carbonate, calcium hydrogencarbonate, calcium oxide, magnesium oxide, magnesium carbonate. Examples of nitrogen-containing compounds are ammonia, ethylamine, butylamine, triethylamine, trimethylamine, tributylamine, N,N-dimethyldecylamine, triisooctylamine, urea, tetramethylurea, guanidine, tetramethylguanidine, N-methylimidazole, N-ethylimidazole, piperidine, pyridine, picoline, N-methylmorpholine. Amine compounds are preferably employed in which the nitrogen atoms do not carry any hydrogen atoms. The auxiliary base is preferably used in an at least equimolar amount relative to the halosilane. Per mole equivalent of halosilane, use is made preferably of at least 0.5, more preferably at least 1.0, more particularly at least 2.0 base equivalents of auxiliary base. It is also possible to use larger added amounts of auxiliary base, if, for example, it is intended to serve simultaneously as solvent. Usually, however, this does not provide any advantage, but instead reduces the space-time yield and hence the economic viability of the process. The halosilane is preferably added to the anhydrous reaction mixture from the first step of the process, and then the auxiliary base is metered in. This procedure may also, optionally, be reversed, so that the auxiliary base is added first to the reaction mixture from the first synthesis step, and the halosilane is metered in subsequently.

Mixtures of two or more auxiliary bases may also be used.

The one or more halosilanes of the formula (VI) are preferably used so that the amount of halide radicals present is equimolar to the silanol radicals in the polyorganosiloxane species from the first reaction step.

The reaction of the one or more halosilanes of the formula (VI) with the silanol radicals of the polyorganosiloxane species from the first reaction step takes place preferably at a temperature of at least −20° C., more preferably of at least 0° C., more particularly of at least 10° C. The maximum permissible temperature is dictated, furthermore, by the boiling point of the solvent used and of the one or more halosilanes of the formula (VI), with the reaction temperature preferably not exceeding 200° C., more preferably 175° C., more particularly 150° C.

The reaction mixture may be cooled or heated as and when required, and individual reaction components may optionally be adjusted to temperature in advance, before they are reacted with one another, for the purpose, for example, of being able to utilize the heat of reaction. The process may be performed either batchwise in stirred reactors or continuously in column, loop, fluidised-bed or tube reactors. Any low molecular weight siloxanes formed in the reaction can be removed from the reaction mixture by distillation as and when required. The halide salts formed in the reaction may be decanted off, filtered off, or removed by centrifugation, or dissolved in water and separated off. For the aqueous work-up, the amount of solvent already present may be adapted as and when required, in order, for example, to facilitate the phase separations by establishing density differences, or else further solvents may be added, the solubility or miscibility with water of which is very low, more particularly not more than 5 wt % at 25° C.

Preferably any excess of halosilane of the formula (VI) is removed by distillation prior to the aqueous work-up. This avoids the presence of an aqueous acidic solution, which might possibly lead to the formation of silanol groups again on the polyorganosiloxane.

The second reaction step is performed preferably in the absence of moisture, i.e. in a dried atmosphere, or under reduced pressure, more preferably under inert gas such as argon, nitrogen, carbon dioxide or lean air, preferably at 900 to 1100 hPa.

Suitable aprotic solvents for both the first and second steps include, in particular, aromatic hydrocarbon solvents such as benzene, toluene, o-xylene, m-xylene, p-xylene, ethylbenzene or mixtures thereof. Depending on the radicals selected, it may also be possible to use aliphatic or cycloaliphatic solvents, and also linear or cyclic ethers. The suitability of solvent is determined by its solvency for the resultant polyorganosiloxanes. The solvent must dissolve the resultant polyorganosiloxane sufficiently well, must not be miscible with water, i.e. may not itself be able to dissolve more than 5 wt % of water, and must not participate in the reaction.

The suitability of the solvent may optionally be determined by suitable experiments. Aromatic solvents meet the stated conditions the best and are therefore preferred.

It may be noted at this point that the use of disiloxanes, which are used generally in the form of symmetrical disiloxanes, for the purpose of reducing the number of silanol groups is ruled out as being not in accordance with the invention. While disiloxanes do cleave in the presence of acids by breakage of the Si—O—Si bond, the acids for this purpose are generally used as an aqueous preparation, which would deliberately introduce water into the second step of the synthesis; as a result, the tendency for silanol groups to reform could not be ruled out and the second step would no longer be anhydrous and would be reduced in its efficiency.

The polyorganosiloxanes of the formula (I) are chemically curable, meaning that they can be cured by a chemical reaction to form a crosslinked insoluble network. The curing takes place by way of the olefinically unsaturated groups described earlier on above. Typically here either a radical polymerization reaction is employed for the curing or, if there is silicon-bonded hydrogen present as a radical, as well as the olefinically or acetylenically unsaturated functional groups, a hydrosilylation cure is employed.

The polyorganosiloxanes of the formula (I) possess all of the olefinically functional groups via which they are chemically crosslinkable. Possible chemical crosslinking reactions here encompass the known reactions as in the prior art, especially radical crosslinking, which may be initiated both using suitable radiation sources such as UV light and by unstable chemical compounds which decompose to form radicals, and the addition crosslinking is carried out, for example, by hydrosilylation of the olefinically unsaturated group with an Si—H function in the presence of a suitable hydrosilylation catalyst.

Sufficient curing requires the presence of a sufficient amount of functional groups. At the least there must be on average 1.0 functional groups present per molecule of polyorganosiloxane used in the invention, in order to achieve sufficient curing, and preferably there are on average at least 1.1, more particularly on average at least 1.2, functional groups present per molecule of polyorganosiloxane of the invention. The functional groups here may differ: for example, one part of the functional groups is an Si—H group and another part of the functional groups represents an olefinically unsaturated group which is radically curable or hydrosilylatable. Further combinations of complementary functional groups are also conceivable, with complementary meaning that the chosen combinations of functional groups are able to react with one another. If there is only one kind of functional groups present, for example only olefinically or acetylenically unsaturated functional groups which are radically curable, then there must be the corresponding number of these functional groups. In the context of copolymerization to form a homogeneous matrix, it must be ensured here that the olefinic and acetylenic groups selected have sufficient copolymerizability. The combination of olefinic groups which are not copolymerizable with one another is also possible, provided that the resulting matrix of two or optionally more individual polymers remains mutually compatible and does not form separate phases which part from one another in distinct domains.

Examples of suitable initiators for starting the radical polymerization include here, in particular, examples from the field of the organic peroxides, such as di-tert-butyl peroxide, dilauryl peroxide, dibenzoyl peroxide, dicumyl peroxide, cumyl peroxyneodecanoate, tert-butyl peroxyneodecanoate, tert-amyl peroxypivalate, tert-butyl peroxypivalate, tert-butyl peroxyisobutyrate, tert-butyl peroxy-3,5,5-trimethylhexanoate, tert-butyl cumyl peroxide, tert-butyl peroxyacetate, tert-butyl peroxybenzoate, 1,1-ditert-butyl peroxycyclohexane, 2,2-di(tert-butylperoxy)butane, bis(4-tert-butylcyclohexyl) peroxydicarbonate, hexadecyl peroxydicarbonate, tetradecyl peroxydicarbonate, dibenzyl peroxydicarbonate, diisopropylbenzene dihydroperoxide,
1,3-phenylenebis(1-methylethylidene) bis(tert-butyl)peroxide, 2,5-dimethyl-2,5-di-(tert-butylperoxy)hexane, dicetyl peroxydicarbonate, acetylacetone peroxide, acetyl cyclohexanesulfonyl peroxide, tert-amylhydroperoxide, tert-amylperoxy-2-ethylhexanoate, tert-amylperoxy-2-ethylhexyl carbonate, tert-amyl peroxyisopropyl carbonate, tert-amyl peroxyneodecanoate, tert-amyl peroxy-3,5,5-trimethylhexanoate, tert-butyl monoperoxymaleate, with this recitation being merely illustrative and not limiting. It is also possible, optionally, to use mixtures of different initiators for radical reactions. The suitability of an initiator or intiator mixture for radical reactions is dependent on its decomposition kinetics and on the requirement conditions that must be met. If sufficient attention is paid to these boundary conditions, the skilled person is able to select an initiator appropriately.

In the case of preparations which as well as olefinically and acetylenically unsaturated groups also contain silicon-bonded hydrogen, the possibility exists of curing by means of a hydrosilylation reaction. Suitable catalysts for promoting the hydrosilylation reaction are the known catalysts from the prior art.

Examples of such catalysts are compounds or complexes from the group of the noble metals, comprising platinum, ruthenium, iridium, rhodium and palladium, preferably metal catalysts from the group of the platinum metals or compounds and complexes from the group of the platinum metals. Examples of such catalysts are metallic and finely divided platinum, which may be present on supports such as silicon dioxide, aluminium oxide or activated carbon; compounds or complexes of platinum such as platinum halides, e.g. PtCl₄, H₂PtCl₆×6H₂O, Na₂PtCl₄×4H₂O, platinum-olefin complexes, platinum-alcohol complexes, platinum-alkoxide complexes, platinum ether complexes, platinum aldehyde complexes, platinum ketone complexes, including reaction products of H₂PtCl₄×6H₂O and cyclohexanone, platinum-vinylsiloxane complexes, such as platinum-1,3-divinyl-1,1,3,3-tetramethyldisiloxane, with or without the presence of detectable inorganically bonded halogen, bis(gamma-picoline)platinum chloride, trimethylenedipyridine platinum chloride, dicyclopentadiene platinum dichloride, dimethylsulfoxyethenylplatinum(II) dichloride, cyclooctadieneplatinum dichloride, norbornadieneplatinum dichloride, gammapicolineplatinum dichloride, cyclopentadieneplatinum dichloride, and reaction products of platinum tetrachloride with olefin and primary or secondary amine or primary and secondary amine such as the reaction product of platinum tetrachloride in solution in 1-octene with sec-butylamine, or ammonium-platinum complexes. A further embodiment of the process of the invention uses complexes of iridium with cyclooctadienes, for example μ-dichlorobis(cyclooctadiene)diiridium(I).

This recitation is merely illustrative and not limiting. The development of the hydrosilylation catalysts is a dynamic research territory which is continually producing new active species which, of course, may likewise be used here.

The hydrosilylation catalyst preferably comprises compounds or complexes of platinum, more preferably platinum chlorides and platinum complexes, more particularly platinum-olefinic complexes, and very preferably platinum-divinyltetramethyldisiloxane complexes.

In the process of the invention the hydrosilylation catalyst is used in amounts of 2 to 250 weight-ppm, preferably in amounts of 3 to 150 ppm, more particularly in amounts of 3 to 50 ppm.

In one preferred embodiment the polyorganosiloxanes of the formula (I) are joined in a third step to a metal substrate.

The polyorganosiloxanes of the formula (I) are especially suitable for use as binders and/or as adhesive promoters for producing metal-clad laminates, especially for electronic applications, more particularly for metal-faced laminates, and especially for use in radiofrequency applications, particularly those which are operated at frequencies of 1 GHz and above. Particular preference is given to the production of metal-faced electrolaminates, of the kind used for production as printed circuit boards in electronic devices, especially for radiofrequency applications.

Said metal-faced electrolaminates may contain reinforcing materials, but need not. This means that they may be free from or may contain, for example, reinforcing fabrics such as fibre wovens or nonwovens. If a reinforcing material is included, it is preferably arranged in layers. A reinforcing layer in this case may be constructed from a multiplicity of different fibres.

Reinforcing layers of these kinds help to control the shrinkage characteristics and provide enhanced mechanical strength.

If a reinforcing layer is used, the fibres which form this layer may be selected from a multiplicity of different possibilities. Non-limiting examples of such fibres are glass fibres, such as E-glass fibres, S-glass fibres and D-glass fibres, silica fibres, polymer fibres, such as polyetherimide fibres, polysulfone fibres, polyetherketone fibres, polyester fibres, polycarbonate fibres, aromatic polyamide fibres, or liquid-crystalline fibres. The fibres may have a diameter of 10 nm to 10 μm. The reinforcing layer has a thickness of at most 200 μm, preferably at most 150 μm.

One preferred form of application is the use of the polyorganosiloxanes of the formula (I) as binders or cobinders together with organic binders for producing metal-faced laminates comprising glass fibre composites for the further production of printed circuit boards. The preferred metal is copper.

For the use of the polyorganosiloxanes of the formula (I) in the invention they may be used as the sole binder. Alternatively they may be used in a form blended with organic monomers, oligomers and polymers.

Organic monomers, oligomers and polymers typically used for these purposes comprise polyphenylene ethers, bismaleimides, bismaleimide-triazine copolymers, hydrocarbon resins, both aliphatic resins such as polybutadiene and aromatic resins such as polystyrene, for example, and also hybrid systems, possessing both aliphatic and aromatic character, such as styrene-polyolefin copolymers, for example, there being in principle no limitation on the form of the copolymers; epoxy resins, cyanate ester resins, and optionally others, the selection being illustrative and non-limiting.

Preferred organic monomers, oligomers and polymers are oligomeric and polymeric polyphenylene ethers, monomeric, oligomeric and polymeric bismaleimides, oligomeric and polymeric hydrocarbon resins, and bismaleimide-triazine copolymers. These organic monomers, oligomers and polymers may optionally be used in mixtures with one another. The fraction of the organic monomers, oligomers and polymers in the preparations with the polyorganosiloxanes of the formula (I), if the organic components are used as well, is between 10% and 90%, based on the mixture of the polyorganosiloxanes of the formula (I) and the organic monomers, oligomers and polymers as 100%, preferably 20-90%, more particularly 30-80%. Furthermore, not only the polyorganosiloxanes of the formula (I) but also the mixtures thereof with organic monomers, oligomers or polymers may be dissolved in further organic monomers, optionally with olefinically or acetylenically unsaturated groups, as reactive diluents, such as, for example, styrene, alpha-methylstyrene, para-methylstyrene and vinylstyrene, chloro- and bromostyrene.

It is also possible to use typical non-reactive solvents for dissolving the polyorganosiloxanes of the formula (I) and optionally mixtures thereof with organic monomers, oligomers and polymers, such as, for example, aliphatic or aromatic solvents such as aliphatic mixtures with defined boiling ranges, toluene, xylene, ethylbenzene or mixtures of these aromatics, ketones, such as acetone, methyl ethyl ketone and cyclohexanone, carboxylic esters, such as ethyl acetate, methyl acetate, ethyl formate, methyl formate, methyl propionate and ethyl propionate; effective solubility particularly of the mixtures of polyorganosiloxanes of the formula (I) with organic monomers, oligomers and polymers is most likely to be achieved in aromatic solvents such as toluene, xylene, ethylbenzene and mixtures thereof.

In the event that the polyorganosiloxanes of the formula (I) are used in combination with an organic oligomer or polymer or mixtures thereof, it is essential that polyorganosiloxanes of the formula (I) are used which are compatible with the organic components of choice and which do not lead to phase separations. In these events, in general, more phenyl-rich polyorganosiloxanes of the formula (I) should be used, since phenyl groups increase compatibility with the organic components. Especially with relatively aromatic-rich organic polymers such as polyphenylene ethers or aromatic hydrocarbon resins, more aromatic-rich polyorganosiloxanes of the formula (I) should be used, with the bridging aromatic groups and aromatic substituents bonded terminally on silyl units both contributing to the establishment of compatibility. The precise amount of the aromatic groups that is needed to establish compatibility of the polyorganosiloxanes of the formula (I) with a defined selection of organic binders must be ascertained depending on the selection of organic binders. It is likewise possible to mix two or more organic polymers, selected optionally from different polymer classes, and use them in the binder preparation. It is also possible to combine two or more polyorganosiloxanes of the formula (I) with one another in a binder preparation. That is, in accordance with the invention, use may be made either of only one single polyorganosiloxane of the formula (I) as binders or else a combination of two or more polyorganosiloxanes of the formula (I) with one another to form a binder preparation. It is also possible in the invention to combine only one polyorganosiloxane of the formula (I) with one or more organic polymers to form a binder preparation. Also in accordance with the invention is the combination of two or more polyorganosiloxanes of the formula (I) with one or more different organic polymers to form a binder preparation.

Determining the compatibility of one or more polyorganosiloxanes of the formula (I) with one or more organic oligomers or polymers is easily accomplished by mixing a mixture of the one or more organic binders with the one or more polyorganosiloxanes of the formula (I), advantageously in a solvent which dissolves all of the selected components, and then removing the solvent by prior-art methods, such as by distillation or spray-drying, for example, and subjecting the resulting residue to visual evaluation or evaluation with the aid of microscopic methods, possibly electron-microscopic methods. Compatible mixtures are apparent from the absence of any silicone domains which separate from the organic constituents and are recognisable as an independent phase.

The use of further formulating components, such as additives, which optionally may also include silanes, such as, for example, antifoams and deaerating agents, wetting and dispersing agents, flow control agents, compatibilizers, adhesion promoters, curing initiators, catalysts, stabilisers, fillers including pigments, dyes, inhibitors, flame retardants and crosslinking assistants, for example, is in accordance with the invention, and there is in principle no limitation on the selection of such components. Aside from tests of the compatibility in the sense of a suitable miscibility behaviour, tests of compatibility in terms of reactivity may also be necessary, in order both to prevent premature gelling and to ensure that on curing there is sufficiently rapid polymerization or copolymerization of all of the components with one another, and also tests for sufficient wetting and optionally other properties. This may need to be borne in mind and taken into account when drawing up the formulation.

Examples of fillings which can be used are ceramic fillers such as, for instance, silicas, for example precipitated silicas or fumed silicas, which may be of a hydrophilic or hydrophobic and preferably hydrophobic and which, furthermore, may also be equipped functionally, and optionally reactively, with organic groups on their surface; quartz, which may optionally have been surface-treated or surface-functionalized, allowing it to carry reactive functional groups on the surface; aluminium oxides, aluminium hydroxides, calcium carbonate, talc, mica, alumina, kaolin, magnesium sulfate, carbon black, titanium dioxide, zinc oxides, antimony trioxide, barium titanate, strontium titanate, corundum, wollastonite, zirconium tungstate, hollow ceramic beads, aluminium nitride, silicon carbide, beryllium oxide, magnesium oxide, magnesium hydroxide, solid glass beads, hollow glass beads and boron nitride. Further fillers used may be core-shell particles of various materials, such as, for instance, silicone resin beads with a surface covering of silica, and elastomer particles with a covering of polymer, in which case the elastomer particles may optionally also be silicone elastomers, and a typical example of surface coverage on an elastomer particle of this kind is a polymethylmethacrylate shell. The ceramic fillers preferably have particle sizes, expressed as D₉₀, of 0.1 μm to 10 μm.

Fillers are present preferably in amounts of 0.1 to 60 weight percent, more preferably of 0.5 to 60 weight percent, more particularly of 1 to 60 weight percent, based on the overall binder formulation consisting of binder or binders, reactive monomers, additives and fillers as 100 percent. This means that the amount of any non-reactive solvent used is not included.

Among the fillers, particular emphasis should be given to those which have thermal conductivity. These are aluminium nitride, boron nitride, silicon carbide, diamond, graphite, beryllium oxide, zinc oxide, zirconium silicate, magnesium oxide, silicon oxide and aluminium oxide.

In principle the binder preparations may comprise flame retardant additives in an amount of typically 5 to 25 weight percent. A particular feature of the polyorganosiloxanes of the formula (I), however, is that they reduce the requirement for flame retardant additives, as the polyorganosiloxanes of the formula (I) themselves already exhibit flame retardancy properties. Polysilsesquioxanes and siloxanes are known for exhibiting flame retardancy properties, and their use themselves as flame retardant additives is part of the prior art. It is therefore a particular advantage of the present invention that in this case the function of the binder can be linked with the function of flame retardancy. Depending on the amount of polyorganosiloxanes of the formula (I) used, therefore, the amount of flame retardant additives can be reduced. For an amount of at least 20 weight percent based on the total mixture of all the binders used and reactive organic monomers, the amount of flame retardant additives is preferably only 0 to 10 weight percent, more preferably 0 to 8 weight percent, more particularly 0 to 5 weight percent; in other words, it is possible when using the polyorganosiloxanes of the formula (I), depending on the selection of the organopolysiloxane and on the amount employed, to omit the use of a flame retardant additive.

Typical examples of flame retardant additives are hydrates of the metals Al, Mg, Ca, Fe, Zn, Ba, Cu or Ni and borates of Ba and Zn. The flame retardant additives may be surface-treated, in which case they may optionally possess reactive groups on the surface. The flame retardant additives may also be halogenated organic flame retardant additives, such as, for example, hexachloroendomethylenetetrahydrophthalic acid, tetrabromophthalic acid or dibromoneopentyl glycol. Examples of further flame retardant additives are melamine cyanurate, phosphorus-containing components, such as phosphinates, diphosphinates, phosphazenes, vinylphosphazenes, phosphonates, phosphaphenanthrene oxides, and fine-granular melamine polyphosphates. Further examples of bromine-containing flame retardant additives are bispentabromophenylethane, ethylenebistetrabromophthalimide, tetradecabromodiphenoxybenzene, decabromodiphenyl oxide or brominated polysilsesquioxanes. Certain flame retardant additives are boosted synergistically in their effect. This is the case, for example, for the combination of halogenated flame retardancy additives with antimony trioxide.

Further examples of other components are antioxidants, stabilisers against degradation by weathering, lubricity agents, plasticisers, colouring agents, phosphorescent or other agents for labelling and traceability, and antistatic agents. The polyorganosiloxanes of the formula (I) are preferably crosslinked in a fourth step.

Crosslinking assistants employed include, in particular, polyunsaturated, radically curable or hydrosilylatable monomers and oligomers, as illustrated in non-limiting examples below. They include, for example, diolefinically unsaturated components such as, for example, symmetrically olefinically unsaturated disubstituted disiloxanes, such as 1,1,3,3-tetramethyl-1,3-divinyldisiloxane, 1,1,3,3-tetramethyl-1,3-dipropylmethacryloyldisiloxane, diolefinically unsaturated disubstituted organic monomers or oligomers with, for example, diallyl, divinyl, diacryloyl or dimethacryloyl substitution, such as, for example, conjugated and non-conjugated dienes, such as 1,9-decadiene, 1,3-butadiene. They also include triolefinically unsaturated monomers or oligomers such as 1,2,4-trivinylcyclohexane, triallyl cyanurates or triallyl isocyanurates, tri(meth)acrylates, such as trimethylolpropane trimethacrylate, for example.

Also included here are tetraunsaturated substituted monomers and oligomers such as, for example, 2,4,6,8-tetramethyl-2,4,6,8-tetravinylcyclotetrasiloxane, 2,4,6,8-tetraphenyl-2,4,6,8-tetravinylcyclotetrasiloxane, 2,2-bis[[(2-methyl-1-oxoallyl)oxy]methyl]-1,3-propanediyl bismethacrylate (pentaerythritol tetramethacrylate), tetraallylorthosilicate, tetraallyl cis,cis,cis,cis-1,2,3,4-cyclopentanetetracarboxylate, tetraallylsilanes, glyoxal bis(diallylacetal).

Because of the conceivable possibility of hydrosilylation curing in addition to radical curing, multiply Si—H-functional components may also act as crosslinkers, such as, for example, 1,1,3,3-tetramethyl-1,3-disiloxane, 2,4,6,8-tetramethyl-cyclotetrasiloxane, 1,4-bis(dimethylsilyl)benzene or oligo- and polyorganosiloxanes with multiply in-chain and/or terminal Si—H functionality.

Suitable catalysts and/or initiators for the radical curing of the binder preparations composed of polyorganosiloxanes of the formula (I) and organic monomers, oligomers and polymers are the same as those already identified earlier on above—thus, in particular peroxides. Furthermore, for initiating the radical curing both of the polyorganosiloxanes of the formula (I) alone and of the binder preparations described, there are further radical initiators that are suitable, such as, for example, azo components, such as α,α′azobis(isobutyronitrile), redox initiators such as combinations of peroxides such as hydrogen peroxide and iron salts, or azides such as acetyl azide, for example.

The polyorganosiloxanes of the formula (I) and/or the preparations comprising them may be used either as a solvent-free or as a solvent-containing preparation for use in accordance with the invention. In general they are used as a solvent-containing preparation, in order to facilitate the homogeneous distribution of all of the components of the formulation in one another and to facilitate the wetting and saturation of any reinforcing layer used. In general a reinforcing layer is used. It is preferably a glass fibre fabric. The saturation of the reinforcing layer may be accomplished by impregnative application with the preparation, for which there are various technical solutions available, including, optionally, continuous processes, the selection of which for the purpose of producing the metal-faced laminates of the invention is not limited in any way. Non-limiting examples of application technologies are the immersion, where appropriate of webs of the reinforcing material via roller systems in continuous operations; spraying, flowcoating, knifecoating, etc. It is an advantage of the present invention that all of the technologies available can be employed without limitation and modification, and no special new process is needed for the use of polyorganosiloxanes of the formula (I). Accordingly, in the production of the metal-faced laminates, the present invention is entirely within the available state of the art. The new feature is the use of the polyorganosiloxanes of the formula (I) for producing the metal-faced laminates in question, which was hitherto unknown.

The impregnating is followed by a drying step, in which any solvent used is removed. For the drying operation as well, prior-art methods are employed. These methods encompass, in particular, thermally induced evaporation with or without reduced pressure. By appropriate setting of the reactivity and of the tack of the binder mixture used, the products of this step under suitable conditions, such as cooling, for example, are storable composite materials, which can optionally be further-processed at a later point in time.

In a last step of the process, the binder preparation is polymerized, again according to prior-art methods. Any initiators of the radical polymerization that are used here are heated beyond their decomposition temperature, and so they break down, forming radicals, and initiate the radical polymerization of the binder preparation. Methods of radiation curing are also employable in principle.

If hydrosilylation curing is used instead of radical polymerization, the temperature to be employed in this step is a temperature suitable for deactivating the hydrosilylation catalyst used, with inhibitor used, and for releasing the catalytic activity of the hydrosilylation catalyst.

This step takes place in general at an elevated temperature of preferably 100 to 390° C., more preferably 100 to 250° C., more particularly of 130 to 200° C., with the temperature being effective for a time of preferably 5 to 180 min, more preferably 5 to 150 min, more particularly 10 to 120 min. It is also customary in this step to employ elevated pressure. Customary pressures are in the range from 1 to 10 MPa, more preferably from 1 to 5 MPa, more particularly from 1 to 3 MPa.

The lamination of the composite material with a conductive metal layer takes place in this second step, by applying a layer of at least one selected metal to one or both sides of the composite material composed of reinforcing layer and binder preparation, before the curing takes place. In other words, between the first step, consisting of impregnating and drying, and the second step, comprising the chemical curing of the binder preparation, the composite from the first step is faced with at least one variety of a conductive metal.

Suitable conductive metals include in particular at least one from the following selection: copper, stainless steel, gold, aluminium, silver, zinc, tin, lead and transition metals. There are in principle no limitations on the thickness of the conductive layer or on its shape, size or surface texture. The conductive metal layer preferably has a thickness of 3 to 300 μm, more preferably of 3 to 250 μm, more particularly of 3 to 200 μm. Where two layers are used, the thickness of the two layers of at least one variety of a conductive metal may vary and need not be identical. With particular preference the conductive metal is copper, and, in the event that two conductive layers of conductive metal are used, both layers are copper. The conductive metal is used preferably in the form of a foil of the relevant metal. The mean roughness Ra of the metal foil used is preferably at most 2 μm, more preferably at most 1 μm, more particularly at most 0.7 μm. The lower the surface roughness, the better the suitability of the respective foil for use in radiofrequency applications, which are the preferred objective of the present invention. To improve the adhesion between the conductive metal layer and the composite composed of binder preparation and reinforcing layer, it is possible optionally to use various methods from the prior art, such as, for example, the use of an adhesion-promoting layer, the electrochemical deposition of the metal layer on the composite composed of binder preparation and reinforcing layer, or vapour deposition. The layer of conductive metal may sit directly on the composite composed of binder preparation and reinforcing layer, or may be joined thereto by an adhesion-promoting layer.

If a reinforcing layer is not used, a layer of the binder preparation comprising the polyorganosiloxanes of the formula (I) is produced by depositing a layer of binder preparation on a carrier, such as a release film or release plate, for example, material suitable for the carrier being in principle any material from which the dried or cured binder preparation can later be detached again, such as, for example, polytetrafluoroethylene, polyesters and the like. The detachability and the film-forming properties on the carrier material in question must be determined individually depending on the binder composition. The statements made regarding the process remain equally valid for this reinforcement-free variant.

From the reinforced or unreinforced composite materials from the first step, and the laminated composite materials from the second step, multi-layer systems can be constructed, by stacking multiple plies of the composite materials from the first step in alternation, for example, with the faced laminates from the second step, one above another, and then curing the as yet uncured composite materials from the first step in an operation corresponding substantially to the procedure for producing the metal-faced laminates. In order to produce thicker layers, it is also possible here to stack multiple plies of the reinforced or unreinforced composites from the first step one over another in direct order.

As well as for producing metal-faced laminates, the polyorganosiloxanes of the formula (I) can also be used in anticorrosion preparations, particularly for use for corrosion prevention at high temperature.

Moreover, the polyorganosiloxanes of the formula (I) and preparations comprising them may also be used for corrosion protection of reinforcing steel in steel-reinforced concrete. Corrosion inhibition effects in steel-reinforced concrete are in that case achieved both when the polyorganosiloxanes of the formula (I) and preparations comprising them are introduced into the concrete mixture before the mixture is shaped and cured, and when the polyorganosiloxanes of the formula (I) or preparations comprising them are applied to the surface of the concrete after the concrete has cured.

As well as for corrosion protection on metals, the polyorganosiloxanes of the formula (I) may also be used for manipulating further properties of preparations which comprise the organopolysiloxanes of the invention, or of solid bodies or films obtained from preparations comprising the polyorganosiloxanes of the formula (I), examples of these properties being as follows:
controlling electrical conductivity and electrical resistance
controlling the flow properties of a preparation
controlling the gloss of a wet or cured film or an object
increasing weathering resistance
increasing chemicals resistance
increasing hue stability
reducing chalking propensity
reducing or increasing static and sliding friction on solid bodies or films obtained from preparations comprising the polyorganosiloxanes of the formula (I)
stabilising or destabilising foam in the preparation comprising the preparation
improving adhesion of the preparation comprising the polyorganosiloxanes of the formula (I) to substrates
controlling the filler and pigment wetting and dispersing behaviour
controlling the rheological properties of the preparation comprising the organopolysiloxanes of the invention
controlling mechanical properties, such as flexibility, scratch resistance, elasticity, extensibility, bendability, breaking behaviour, resilience behaviour, hardness, density, tear resistance, compression set, behaviour at different temperatures, expansion coefficient, abrasion resistance, and also further properties such as thermal conductivity, combustibility, gas permeability, stability to water vapour, hot air, chemicals, weathering and radiation, sterilizability, of solid bodies or films obtainable comprising the polyorganosiloxanes of the formula (I) or preparations comprising them
controlling electrical properties, such as, for example, dielectric loss factor, breakdown resistance, dielectric constant, leakage current resistance, arc resistance, surface resistance, specific breakdown resistance,
flexibility, scratch resistance, elasticity, extensibility, bendability, breaking behaviour, resilience behaviour, hardness, density, tear resistance, compression set, behaviour at different temperatures of solid bodies or films obtainable from the preparation comprising the polyorganosiloxanes of the formula (I).

Examples of applications in which the polyorganosiloxanes of the formula (I) can be used to manipulate the properties designated above are the production of coating materials and impregnations and coatings obtainable therefrom on substrates, such as metal, glass, wood, mineral substrate, synthetic and natural fibres for producing textiles, carpets, floor coverings or other wares producible from fibres, leather, and plastics such as films and mouldings. With appropriate selection of the preparation components, the polyorganosiloxanes of the formula (I) may additionally be used in preparations as an additive for the purpose of defoaming, flow promotion, hydrophobization, hydrophilization, filler and pigment dispersion, filler and pigment wetting, substrate wetting, promotion of surface smoothness, reduction of static and sliding friction on the surface of the cured material obtainable from the additised preparation. The polyorganosiloxanes of the formula (I) may be incorporated in liquid form or in cured solid form into elastomer compositions. In that case they can be used for reinforcement or for improving other service properties, such as controlling transparency, heat resistance, yellowing propensity or weathering stability.

All of the above symbols in the above formulae have their definitions each independently of one another. In all formulae the silicon atom is tetravalent.

### EXAMPLES

All percentages are based on weight. Unless otherwise indicated, all operations are performed at room temperature of 23° C. and under standard pressure (1.013 bar). Unless otherwise indicated, all data relating to description of product properties are valid at room temperature from 23° C. and under standard pressure (1.013 bar). The apparatus used is standard commercial laboratory instruments of the kind available commercially from numerous instrument manufacturers.
Ph denotes a phenyl radical=C₆H₅—.
Me denotes a methyl radical=CH₃—. Me₂ accordingly denotes two methyl radicals.
PPE denotes polyphenylene ether.
HCl denotes hydrogen chloride.

In the present text, substances are characterized by means of data obtained using instrumental analysis. The underlying measurements are performed either according to publically available standards or are determined according to specially developed methods. To ensure the clarity of the teaching imparted, the methods used are specified hereinbelow.

In all examples, the statements of parts and percentages relate to weight, unless otherwise indicated.

### Viscosity:

Unless otherwise indicated, the viscosities are determined by rotational viscometry measurement according to DIN EN ISO 3219. Unless otherwise indicated, all reported viscosities are for 25° C. and standard pressure of 1013 mbar.

### Refractive Index:

The refractive indices are determined in the wavelength range of visible light, unless otherwise indicated, at 589 nm at 25° C. and standard pressure of 1013 mbar in accordance with standard DIN 51423.

### Transmission:

The transmission is determined by UV VIS spectroscopy. An example of a suitable instrument is the Analytik Jena Specord 200.

The measuring parameters used are as follows: range: 190-1100 nm

Step width: 0.2 nm, integration time: 0.04 s, measuring mode: step mode. The reference measurement (background) is performed first. A quartz plate secured to a sample holder (quartz plate dimensions: H×B around 6×7 cm, thickness around 2.3 mm) is placed into the sample beam path and measured against air.

Sample measurement then follows. A quartz plate secured to the sample holder and carrying the applied sample—layer thickness of applied sample around 1 mm—is placed into the sample beam path and measured against air. Internal calculation relative to the background spectrum yields the transmission spectrum of the sample.

### Molecular Compositions:

The molecular compositions are determined using nuclear magnetic resonance spectroscopy (for terminologies see ASTM E 386: High-resolution nuclear magnetic resonance (NMR) spectroscopy: terms and symbols), with measurement of the ¹H nucleus and the ²⁹Si nucleus.

### Description of ¹H-NMR Measurement:

Solvent: CDCl3, 99.8% d
Sample concentration: around 50 mg/1 ml of CDCl3 in 5 mm NMR tube
Measurement without addition of TMS, spectral referencing of residual CHCl3 in CDCl3 at 7.24 ppm
Spectrometer: Bruker Avance 1 500 or Bruker Avance HD 500
Probe: 5 mm BBO probe or SMART probe (Bruker)

### Measuring Parameters:

Pulprog=zg30
TD=64 k
NS=64 or 128 (depending on probe sensitivity)
SW=20.6 ppm
AQ=3.17 s
D1=5 s
SFO1=500.13 MHz
O1=6.175 ppm

### Processing Parameters:

SI=32 k
WDW=EM
LB=0.3 Hz

Individual adaptations of the measuring parameters may be necessary according to the type of spectrometer used.

### Description of ²⁹Si-NMR Measurement:

Solvent: C6D6 99.8% d/CCl4 1:1 v/v with 1 wt % of Cr(acac)₃ as relaxation reagent
Sample concentration: around 2 g/1.5 ml of solvent in 10 mm NMR tubes
Spectrometer: Bruker Avance 300
Probe: 10 mm 1H/13C/15N/29Si glass-free QNP probe (Bruker)

### Measuring Parameters:

Pulprog=zgig60
TD=64 k
NS=1024 (depending on probe sensitivity)
SW=200 ppm
AQ=2.75 s
D1=4 s
SFO1=300.13 MHz
O1=−50 ppm

### Processing Parameters:

SI=64 k
WDW=EM
LB=0.3 Hz

Individual adaptations of the measuring parameters may be necessary according to type of spectrometer used.

### Molecular Weight Distributions:

Molecular weight distributions are determined as weight average Mw and as number average Mn, using the method of gel permeation chromatography (GPC or size exclusion chromatography (SEC)) with a polystyrene standard and a refractive index detector (RI detector). Unless otherwise identified, THE is used as eluent and DIN 55672-1 is employed. The polydispersity is the quotient Mw/Mn.

### Glass Transition Temperatures:

The glass transition temperature is determined by differential scanning calorimetry (DSC) according to DIN 53765, perforated crucible, heating rate 10 K/min.

### Determination of Particle Size:

The particle sizes were measured by the method of dynamic light scattering (DLS) with determination of the zeta potential.

The following auxiliaries and reagents were used for the determination:

Polystyrene cuvettes of 10×10×45 mm, Pasteur pipettes for single use, ultra-pure water.

The sample for measurement is homogenised and introduced without bubbles into the measuring cuvette.

The measurement takes place at 25° C. after an equilibration time of 300 s, with high resolution and automatic measuring time adjustment.

The values reported always relate to the D(50) value. D(50) is to be understood as the volume-averaged particle diameter at which 50% of all the measured particles have a volume-averaged diameter smaller than the specified value of D(50).

### Determination of the Dielectric Properties: Df, Dk

The dielectric properties are determined according to IPC TM 650 2.5.5.13 using a Keysight/Agilent E8361A network analyser according to the Split-Cylinder Resonator method at 10 GHz.

### Microscopy Procedure:

The micro/nanostructure was characterized by optical microscopy and by transmission electron microscopy respectively.

### Optical Microscopy:

Sample preparation: 1 drop of sample (neat) on slide; covered with cover glass Instrument: LEICA DMRXA2 with LEICA DFC420 CCD camera (2592×1944 pixels) Imaging: transmitted light—interference contrast, various magnification stages

### Transmission Electron Microscopy:

Sample preparation: 1 drop of sample (dilution 1:20, adaptation required if necessary) on coated TEM grid; addition of a contrast agent if required; drying at RT
Instrument: ZEISS LIBRA 120 with Sharp Eye CCD camera (1024×1024 pixels) Imaging: excitation voltage 120 kV; TEM brightfield; various magnification stages

### Peel Strength Test for Adhesion:

The adhesion of the metal layers laminated onto the composite layers with or without reinforcing material was determined according to the IPC-TM 650 2.4.8 method “Peel Strength of Metallic Clad Laminates” in the “as received” version, i.e. without thermal loading or exposure.

A 35 μm copper foil, mass 285±10 g/m², roughness depth Rz≤8 μm, mean roughness Ra≤0.4 μm, was laminated to both sides of a composite layer with a thickness of 100 μm, with curing and laminating taking place under conditions of 180 min at 200° C., 2.0 MPa, 30 mm Hg column.

### Synthesis Example 1: Production of an Organopolysiloxane by the Process of the Invention

A mixture of 1267.8 g (6 mol) of phenyltrichlorosilane, 372.6 g (1.5 mol) of 3-(trimethoxysilyl)propyl methacrylate and 780 g of xylene is metered over the course of 4 hours onto an initial charge of 3600 g of water. The reaction of the chlorosilane in water is exothermic and produces hydrochloric acid, which dissolves in the initial water charge. Care is taken to ensure that the temperature as a result of the exothermic temperature increase does not exceed 50° C., and where appropriate the metering rate is reduced so as not to exceed this temperature limit.

After the end of metering, stirring is continued for 15 minutes and the stirrer is shut off. The reaction mixture separates into an aqueous phase, which contains hydrochloric acid and is at the bottom in the reaction vessel, and an organic silicone phase, which is at the top. The aqueous phase is drained off.

A litre of water is added to the organic phase which remains, and the mixture is stirred for 30 minutes, after which the stirrer is shut off again. The aqueous phase separates to the bottom again and is drained off. This procedure is repeated until the residual HCl content of the organic phase, determined by acid-base titration in accordance with prior art, is <20 ppm.

Should the aqueous phase settle to the top, washing takes place not with fully demineralised water but instead with an aqueous solution containing 10% sodium chloride, or 100 g of sodium chloride is added, the mixture is again for 30 min, after which the phase separation is carried out again.

Thereafter the organic phase is distilled on a water separator at ambient pressure until no further water is separated off, and thus the organic phase is technically water-free.

The residual water content of the organic preparation is determined by Karl Fischer Titration and is 856 ppm.

The amount of silanol groups, expressed as OH groups with a molecular weight of 17 g/mol, is determined by ¹H-NMR to be 1.6 weight percent. For a molecular weight of the intermediate from the first reaction step of Mw=3347 g/mol, this implies a silanol content of 3.2 mol of OH.

The reaction mixture is left to cool to 40° C. and first 318 g (3.2 mol) of dimethyldichlorosilane and subsequently 261 g (3.3 mol) of pyridine are metered in. The first metered feed lasts for 30 minutes, the second for 45 minutes. An exothermic temperature increase is observed. Here as well, the temperature is limited to 50° C. by adaptation of the metering rate. After completion of metering, stirring is carried out for 60 minutes in order to complete the reaction.

After the end of reaction, the reaction mixture is washed with three times one litre of fully demineralised water and the aqueous phase is separated off in each case as described above.

Following the last phase separation, the residual HCl content of the organic phase is <20 ppm. The solvent fraction is reduced by distillation, to establish a solids content of 80% resin—that is, the final resin solution consists of 20% xylene and 80% polyorganosiloxane.

Methoxy groups are not detectable in the NMR. The residual silanol content is 0.05 weight percent, determined by ¹H-NMR spectroscopy.
SEC: Mw=4914 g/mol, Mn=1904 g/mol, polydispersity PD=2.58.

According to ²⁹Si-NMR, the molar composition of the silicon-containing fraction of the preparation is as follows:
Me₂Si(H)O_{1/2}: 30.96%
H₂C=C(CH₃)C(═O)—O—(CH₂)₃—SiO_{3/2}: 13.89%
PhSiO_{3/2}: 55.15%

This product is identified below as 1.1.

### Synthesis Example 2: Production of a Silphenylene-Bridged Organopolysiloxane by the Process of the Invention, and Comparison with a Non-Inventive Hydrolytic Procedure in Both Steps

### Synthesis of the Silphenylene Precursor:

1,4-Bis(dimethoxyphenylsilyl)benzene according to literature protocol of Xunjun Chen, Minghao Yi, Shufang Wu, Lewen Tan, Yixin Xu, Zhixing Guan, Jianfang Ge and Guoqiang Yin: Synthesis of silphenylene-containing siloxane Resins Exhibiting Strong Hydrophobicity and High Water Vapor Barriers, Coatings 2019, 9, 481; doi:10.3390/coatings9080481 www.mdpi.com/journal/coatings

1,4-Bis(dimethoxyphenylsilyl)benzene is obtained by reacting trimethoxyphenylsilane with a Grignard reagent obtained from 1,4-dibromobenzene according to the specified literature protocol in “2.2. Synthesis of the 1,4-bis(dimethoxyphenylsilyl)benzene (BDMPD)”. The structure was confirmed by ¹H-NMR spectroscopy and comparison with the specified literature.

The procedure for the resin synthesis corresponds to that described in synthesis Example 1, with the following differences:

A mixture of
845.2 g (═4 mol) of phenyltrichlorosilane,
546.7 g (1.3 mol) of 1,4-bis(dimethoxyphenylsilyl)benzene,
198.7 g (0.8 mol) of 3-(trimethoxysilyl)propyl methacrylate and
820 g of xylene
and an initial charge of 2400 g of fully demineralised water are used. The metering time is 4 hours.

The resulting intermediate after the first stage possesses a molecular weight of Mw=1247 and contains 3 weight percent of silanol groups, determined as OH with a molecular weight of 17 g/mol by ¹H-NMR, i.e. 2.2 mol of OH.

This will be the end point of the synthesis of US 2018022053, according to the examples reported therein as being illustrative, and in accordance with the text of the description of US 2018022053.

In order to reduce the silanol content, the same procedure is employed as described in synthesis Example 1, but using in this case, in contrast to synthesis Example 1, 265.1 g (2.2 mol) of vinyldimethylchlorosilane and
174 g (2.2 mol) of pyridine.

In the product obtained, methoxy groups are no longer detectable by ¹H-NMR. This means that the methacrylate-functional trimethoxysilane has been fully incorporated by condensation, and the resulting methanol removed during the work-up. The fraction of silanol groups was reduced by the aftertreatment to around 0.05 weight percent (as determined by ¹H-NMR).

By SEC (eluent: toluene) the following molecular weights were determined: Mw=2347 g/mol, Mn=1503 g/mol, polydispersity PD=1.56.

According to ²⁹Si-NMR, the molar composition of the silicon-containing fraction of the preparation is as follows:
Me₂Si(Vi)O_{1/2}: 26.54%
H₂C=C(CH₃)C(═O)—O—(CH₂)₃—SiO_{3/2}: 9.98%
O_{2/2}(Ph)Si—C₆H₄—Si(Ph)O_{2/2}: 15.23%
PhSiO_{3/2}: 48.25%

This product is identified below as 2.1.

Alternatively to the non-hydrolytic procedure of the invention, the following hydrolytic procedure for reducing the silanol groups is performed, which is not mentioned in US 2018022053 but which could in principle fall within the inventive scope thereof, as there is no limitation there on the number of stages in the hydrolytic process.

200 g of water are metered to the xylenic reaction mixture, fully distilled beforehand, to the water-free initial charge from the first reaction step. Thereafter 265.1 g (2.2 mol) of vinyldimethylchlorosilane are slowly metered in, the metering rate being adapted such that the reaction temperature (internal temperature in the reaction vessel) remains limited to below 50° C. After the end of metering, stirring is carried out for 60 min, with neither heating nor cooling, in order to conclude to completion the reaction of the silanol groups with the vinyldimethylchlorosilane or with the tetramethyldivinyldisiloxane which has formed therefrom.

The water phase is separated off as described above and thereafter washed with three times 1 litre of water as already described above. Phase separation may possibly be improved by heating to a heating jacket temperature of 60° C. with the stirrer shut off. After the washes, the HCl content of the xylenic solution is less than 20 ppm.

The amount of toluene is reduced by distillation under reduced pressure (20 mbar) at 110° C. until a solution of 80% of resin in 20% of xylene is obtained.

In the product obtained, methoxy groups are no longer detectable by ¹H-NMR. This means that the methacrylate-functional trimethoxysilane has been fully incorporated by condensation here as well, and the resulting methanol removed during the work-up. The fraction of silanol groups was reduced by the aftertreatment, however, only to 0.9 weight percent (as determined by ¹H-NMR).

By SEC (eluent: toluene) the following molecular weights were determined: Mw=7347 g/mol, Mn=2903 g/mol, polydispersity PD=2.53.

Here a further difference is apparent relative to the process of the invention. The vinyldimethylsilane used for reducing the silanol groups in part forms the symmetrical disiloxane, which is removed distillatively during the work-up and, as a result of the HCl formed on reaction of the chlorosilane with water, catalyses the reaction of the silanol groups, which does result in a reduction in those groups, but as a result of condensation leads to a much higher molecular weight and hence to a significant increase in the risk of the polyorganosiloxane obtained from the first step polymerising into an insoluble product and so becoming unusable. This effect is efficiently avoided by the procedure according to the invention.

According to ²⁹Si-NMR, the molar composition of the silicon-containing fraction of the preparation is as follows:
Me₂Si(Vi)O_{1/2}: 11.54%
H₂C=C(CH₃)C(═O)—O—(CH₂)₃—SiO_{3/2}: 11.98%
O_{2/2}(Ph)Si—C₆H₄—Si(Ph)O_{2/2}: 19.23%
PhSiO_{3/2}: 57.25%

The silanol groups are bonded on the PhSiO_{3/2} units.

This product is identified below as 2.2.

With the hydrolytic procedure, the incomplete reaction of the chlorosilane employed is also recognisable in the NMR data, since in the case of complete reaction into the polyorganosiloxane from the first stage, the fraction of Me₂Si(Vi)O_{1/2} units would have to be much higher. It is therefore clearly shown that the anhydrous procedure is superior to the aqueous procedure for a controlled reduction of the polar silanol groups in a robustly controllable and manageable process.

### Synthesis Example 3: Production of an Organopolysiloxane with Alkylene Bridge by the Process of the Invention, and Comparison with a Non-Inventive Aqueous Procedure

The synthesis according to synthesis Example 1 is repeated, but using the following quantities in deviation from synthesis Example 1:
Phenyltrichlorosilane: 422.6 g (═2 mol)
1,2-bis(dichloromethylsilyl)ethane: 341.35 g (1.35 mol)
198.7 g (0.8 mol) of 3-(trimethoxysilyl)propyl methacrylate
820 g of xylene
and an initial charge of 2400 g of fully demineralised water

The metering time is 4 hours.

The resulting intermediate after the first stage possesses a molecular weight of Mw=2247 and contains 2.5 weight percent of silanol groups, determined as OH with a molecular weight of 17 g/mol by ¹H-NMR, i.e. 3.3 mol of OH.

This will be the end point of the synthesis of US 2018022053, according to the examples reported therein as being illustrative, and in accordance with the text of the description of US 2018022053.

In order to reduce the silanol content, the same procedure is employed as described in synthesis Example 1, but using in this case, in contrast to synthesis Example 1, 397.7 g (3.3 mol) of vinyldimethylchlorosilane and
261 g (3.3 mol) of pyridine.

Methoxy groups are not detectable in the NMR. The fraction of silanol groups was reduced by the aftertreatment to around 0.05 weight percent (as determined by ¹H-NMR).

By SEC (eluent: toluene) the following molecular weights were determined: Mw=2954 g/mol, Mn=1919 g/mol, polydispersity PD=1.53.

According to ²⁹Si-NMR, the molar composition of the silicon-containing fraction of the preparation is as follows:
Me₂Si(Vi)O_{1/2}: 44.29%
H₂C=C(CH₃)C(═O)—O—(CH₂)₃—SiO_{3/2}: 10.78%
O_{2/2}(Me)Si—C₂H₄—Si(Me)O_{2/2}: 18.12%
PhSiO_{3/2}: 26.81%

This product is identified below as 3.1.

Alternatively to the non-hydrolytic procedure of the invention, the following hydrolytic procedure for reducing the silanol groups is performed, which is not mentioned in US 2018022053 but which could in principle fall within the inventive scope thereof, as there is no limitation there on the number of stages in the hydrolytic process.

In analogy to the procedure in synthesis Example 2, 300 g of water are added to the anhydrous initial charge from the first reaction step.

Thereafter 397.7 g (3.3 mol) of vinyldimethylchlorosilane are slowly metered in and the subsequent procedure is as described in synthesis Example 2.

In the product obtained, methoxy groups are no longer detectable by ¹H-NMR. The fraction of silanol groups was reduced by the aftertreatment, however, only to 1.0 weight percent (as determined by ¹H-NMR).
SEC: Mw=6974 g/mol, Mn=2812 g/mol, polydispersity PD=2.48.

According to ²⁹Si-NMR, the molar composition of the silicon-containing fraction of the preparation is as follows:
Me₂Si(Vi)O_{1/2}: 21.69%
H₂C=C(CH₃)C(═O)—O—(CH₂)₃—SiO_{3/2}: 15.09%
O_{2/2}(Me)Si—C₂H₄—Si(Me)O_{2/2}: 25.47%
PhSiO_{3/2}: 37.75%

The silanol groups are bonded on the PhSiO_{3/2} units.

This product is identified below as 3.2.

Here as well, a higher molecular weight and a more incomplete reduction of the silanol groups are achieved in the hydrolytic process than in the non-hydrolytic process of the invention.

### Synthesis Example 4: Production of an Organopolysiloxane with Si—Si Bond by the Process of the Invention, in Comparison with a Non-Inventive Aqueous Procedure

The synthesis according to synthesis Example 1 is repeated, but using the following starting materials and quantities in deviation from synthesis Example 1:
Phenyltrichlorosilane: 422.6 g (═2 mol)
198.7 g (0.8 mol) of 3-(trimethoxysilyl)propyl methacrylate
296.4 g (1.3 mol) of 1,1,2,2-tetrachloro-1,2-dimethyldisilane
820 g of xylene
and an initial charge of 2400 g of fully demineralised water

The metering time is 4 hours.

The resulting intermediate after the first stage possesses a molecular weight of Mw=1867 g/mol and contains 2.9 weight percent of silanol groups, determined as OH with a molecular weight of 17 g/mol by ¹H-NMR, i.e. 3.2 mol of OH.

This will be the end point of the synthesis of US 2018022053, according to the examples reported therein as being illustrative, and in accordance with the text of the description of US 2018022053.

In order to reduce the silanol content, the same procedure is employed as described in synthesis Example 1, but using in this case, in contrast to synthesis Example 1, 385.6 g (3.2 mol) of vinyldimethylchlorosilane and 261 g (3.3 mol) of pyridine.

Methoxy groups are not detectable in the NMR. The fraction of silanol groups was reduced by the aftertreatment to around 0.05 weight percent (as determined by ¹H-NMR).

By SEC (eluent: toluene) the following molecular weights were determined: Mw=2479 g/mol, Mn=1678 g/mol, polydispersity PD=1.47.

According to ²⁹Si-NMR, the molar composition of the silicon-containing fraction of the preparation is as follows:
Me₂Si(Vi)O_{1/2}: 40.34%
H₂C=C(CH₃)C(═O)—O—(CH₂)₃—SiO_{3/2}: 10.96%
O_{2/2}(Me)Si—Si(Me)O_{2/2}: 21.31%
PhSiO_{3/2}: 27.39%

This product is identified below as 4.1.

Alternatively to the non-hydrolytic procedure of the invention, the following hydrolytic procedure for reducing the silanol groups is performed, which is not mentioned in US 2018022053 but which could in principle fall within the inventive scope thereof, as there is no limitation there on the number of stages in the hydrolytic process.

In analogy to the procedure in synthesis Example 2, 300 g of water are added to the anhydrous initial charge from the first reaction step.

Thereafter 385.6 g (3.2 mol) of vinyldimethylchlorosilane are slowly metered in and the subsequent procedure is as described in synthesis Example 2.

In the product obtained, methoxy groups are no longer detectable by ¹H-NMR. The fraction of silanol groups was reduced by the aftertreatment, however, only to 1.1 weight percent (as determined by ¹H-NMR).
SEC: Mw=4974 g/mol, Mn=2006 g/mol, polydispersity PD=2.48.

According to ²⁹Si-NMR, the molar composition of the silicon-containing fraction of the preparation is as follows:
Me₂Si(Vi)O_{1/2}: 18.96%
H₂C=C(CH₃)C(═O)—O—(CH₂)₃—SiO_{3/2}: 15.13%
O_{2/2}(Me)Si—Si(Me)O_{2/2}: 28.08%
PhSiO_{3/2}: 37.83%

The silanol groups are bonded on the PhSiO_{3/2} units.

This product is identified below as 4.2.

Here as well, a higher molecular weight and a more incomplete reduction of the silanol groups are achieved in the hydrolytic process than in the non-hydrolytic process of the invention.

### Use Example 1: Use of the Inventively and Non-Inventively Produced Organopolysiloxanes of Synthesis Examples 1-4 for Producing Metal-Faced Laminates

The organopolysiloxanes produced according to synthesis Examples 1 to 4 and according to the comparative examples contained therein were used as binders in order to produce copper-faced laminates having a glass fibre-reinforced composite layer. Starting materials used were as follows:
Copper foil: 35 μm thick copper foil (285±10 g/m²) from Jiangtong-yates Copper Foil Co Ltd, having a roughness depth of Rz≤8 μm and a mean roughness depth of Ra≤0.4 μm, purity≥99.8%.
Glass fibres: E-Glass fibre type 1080 E produced by Changzhou Xingao Insulation Materials Co. Ltd. Thickness 0.055±0.012 mm, 47.5±2.5 g/m².

In this example all the organopolysiloxanes were used as solutions in xylene. The solutions each contained 80% of organopolysiloxane and 20% of xylene.

To initiate the curing, the organopolysiloxanes were admixed with in each case 1 weight percent of dicumyl peroxide, based on the amount of polyorganosiloxane used, the peroxide being distributed uniformly in the resin matrix by stirring.

Laminates were produced by subjecting glass fibre layers measuring 30×30 cm to ply-by-ply, bubble-free impregnation with the respective organopolysiloxane where appropriate as a xylenic solution, with the aid of an air removal roller. In this procedure the glass fibre layers were mounted on a planar, dimensionally stable stainless steel support, to which one ply of copper foil was applied before the first ply of glass fibres was placed on. In total three plies of glass fibre fabric in each case were successively impregnated. To remove the solvent, where appropriate, the impregnated fabrics were dried to constant weight in a vacuum drying oven at mbar and 60° C. Thereafter a second layer of copper foil was applied to the impregnated glass fibre layer, at the top, and a further dimensionally stable stainless steel plate was placed on. The laminate was heated in a heatable press with a pressure of 2 MPa for 120 minutes at 200° C. and a reduced pressure of 30 mbar. This produces copper-faced laminates having a total thickness of 260±20 μm.

The dielectric properties were determined according to IPC TM 650 2.5.5.13 with a Keysight/Agilent E8361A network analyser according to the Split-Cylinder Resonator method at 10 GHz. Values obtained were as follows:

| Organopolysiloxane | Dₖ | D_{f} |
|---|---|---|
| 1.1 (inventive) | 2.78 | 0.0021 |
| 2.1 (inventive) | 2.89 | 0.0022 |
| 2.2 (not inventive) | 3.20 | 0.0040 |
| 3.1 (inventive) | 2.77 | 0.0023 |
| 3.2 (not inventive) | 3.34 | 0.0041 |
| 4.1 (inventive) | 2.79 | 0.0022 |
| 4.2 (not inventive) | 3.36 | 0.0041 |

The D_{f} and Dₖ values for the copper-faced laminates comprising the organopolysiloxanes of the invention are significantly lower than the D_{f} and Dₖ values achieved with the organopolysiloxanes from the prior-art procedure. Given that extremely low dielectric loss factors and relative permittivities are desirable for radiofrequency applications, the effect according to the invention is markedly apparent.

### Use Example 2: Use of the Inventively and Non-Inventively Produced Organopolysiloxanes of Synthesis Examples 1-4 for Producing Metal-Faced Laminates Via Prepregs

For this example, the organopolysiloxanes from synthesis Examples 1-4 both in accordance with the inventive procedure and in accordance with the non-inventive procedure were used as solutions in xylene, using in each case preparations of 20% of xylene and 80% of polyorganosiloxane.

Instead of constructing the laminate directly without an intermediate prepreg stage, this time prepregs were produced, by impregnating the glass fibre plies, as individual plies in each case on a polytetrafluoroethylene film, with the resin preparation and then drying them to constant weight in a vacuum drying oven. Sets of three plies of impregnated glass fibre fabric produced in this way were subsequently deposited one over the other onto a copper foil, and the stack was concluded with a ply of copper foil. This multi-layer construction was pressed and cured, in analogy to use Example 1, between two dimensionally stable stainless steel plates in a vacuum press under the conditions as indicated in Example 1.

The laminates obtained had thicknesses of 290±20 μm.

The dielectric properties measured on the resultant laminates were as follows:

| Organopolysiloxane | Dₖ | D_{f} |
|---|---|---|
| 1.1 (inventive) | 2.78 | 0.0020 |
| 2.1 (inventive) | 2.89 | 0.0020 |
| 2.2 (not inventive) | 3.20 | 0.0039 |
| 3.1 (inventive) | 2.77 | 0.0021 |
| 3.2 (not inventive) | 3.34 | 0.0040 |
| 4.1 (inventive) | 2.79 | 0.0020 |
| 4.2 (not inventive) | 3.36 | 0.0040 |

The Dₖ and D_{f} values achieved for the copper-faced laminates comprising the organopolysiloxanes produced in accordance with the invention are significantly lower than the Dt and Dk values achieved with the organopolysiloxanes from the comparative examples. Given that extremely low dielectric loss factors and relative permittivities are desirable for radiofrequency applications, the effect according to the invention is markedly apparent.

### Use Example 3: Use of the Inventively and Non-Inventively Produced Organopolysiloxanes of Synthesis Examples 1-4 for Producing Metal-Faced Laminates in a Mixture with Organic Polymers for Producing Metal-Faced Laminates

The procedure corresponds substantially to that described in use Example 2, except that this time organic polymers were mixed with the organopolysiloxanes. The final solvent-free mixtures always contained 30 weight percent of organopolysiloxane and 70 weight percent of organic polymers. Organic polymers were triallyl isocyanurate, NORYL SA 9000, an alphaomega methacrylate-terminated polyphenylene ether acquired from SABIC, Mn=2500 g/mol, Tg=160° C., and B 3000 from Nippon Soda, a liquid polybutadiene with Mn=3200, viscosity at 45° C.=210 poise with more than 85% 1,2-vinyl structure in the polymer chain.

The polymers were always used in the same proportion. They were dissolved or dispersed in xylene, with 30 parts by weight of SA 9000, 25 parts by weight of B 3000 and 15 parts by weight of triallyl isocyanurate being dispersed with 100 parts by weight of xylene.

The resulting preparation was mixed with the xylenic solutions of the organopolysiloxanes in accordance with use Example 2 such that in each case the specified proportion of 30% of organopolysiloxane and 70% of organic components was present in the solution obtained. These solutions were then used, as described in use Example 2, to produce copper-faced laminates via prepregs.

The laminates obtained had thicknesses of 290±20 μm.

The dielectric properties measured on the resultant laminates were as follows:

| with the organo- | | |
|---|---|---|
| polysiloxane from | Dₖ | D_{f} |
| 1.1 (inventive) | 2.91 | 0.0029 |
| 2.1 (inventive) | 2.65 | 0.0022 |
| 2.2 (not inventive) | 3.28 | 0.0040 |
| 3.1 (inventive) | 2.78 | 0.0021 |
| 3.2 (not inventive) | 3.29 | 0.0041 |
| 4.1 (inventive) | 2.59 | 0.0022 |
| 4.2 (not inventive) | 3.21 | 0.0042 |

The Dₖ and D_{f} values achieved for the copper-faced laminates using the organopolysiloxanes produced in accordance with the invention are significantly lower than the D_{f} and Dₖ values achieved with the organopolysiloxanes from the comparative examples. Given that extremely low dielectric loss factors and relative permittivities are desirable for radiofrequency applications, the effect according to the invention is markedly apparent.

1-8. (canceled)

9. Process for preparing polyorganosiloxanes, comprising:
providing polyorganosiloxanes of the formula (I)
[O_{3-a/2}RₐSiY(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g}[O_{3-h/2}R⁴ₕSi(SiR⁵₂)ᵢSiR⁴ⱼO_{3-j/2}]ₖ (I),
wherein the radicals R may be identical or different radicals and are either a hydrogen radical or a monovalent, Si—C-bonded unsubstituted or heteroatom-substituted organic hydrocarbon radical having 1 to 18 carbon atoms, which may also be an unsaturated hydrocarbon radical,
wherein Y is a chemical bond, an oxygen atom or a di- to dodecavalent organic unsubstituted or heteroatom-substituted organic radical having 1 to 24 carbon atoms and bonded to the silicon atoms by Si—C linkage,
wherein radicals R¹, R² and R³ independently of one another are a hydrogen radical or a saturated or unsaturated, Si—C-bonded C1-C18 hydrocarbon radical, which may be unsubstituted or substituted by heteroatoms, or are a C1-C12 hydrocarbon radical which is bonded via an oxygen atom and may contain heteroatoms, or are a silanol radical, where the radicals R¹, R² and R³ may adopt their definition in each case independently of one another, and so two or more radicals R¹, R² and/or R³ bonded on the same silicon atom may be different radicals from the group defined,
wherein radicals R⁴ independently of one another are either a hydrogen radical, a silanol radical or a monovalent, Si—C— or Si—O—C-bonded, unsubstituted or heteroatom-substituted organic hydrocarbon radical having 1 to 18 carbon atoms, which may also be an unsaturated hydrocarbon radical,
wherein radicals R⁵ independently of one another either are a hydrogen radical, a monovalent, Si—C-bonded, unsubstituted or heteroatom-substituted organic hydrocarbon radical having 1 to 18 carbon atoms, which may also be an unsaturated hydrocarbon radical, or are a radical of the formula (II)
[O_{3-a/2}RₐSiY(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g} (II),
wherein based on all the radicals Y, R, R¹, R², R³, R⁴ and R⁵ as 100 mol %, at least 0.1 mol % must be olefinically or acetylenically unsaturated radicals,
wherein based on all the radicals Y, R, R¹, R², R³, R⁴ and R⁵ as 100 weight %, in total at most 3 wt % are Si—O—C-bonded radicals and silanol radicals, and
wherein based on all the radicals Y, R, R¹, R², R³, R⁴ and R⁵ as 100 weight %, in total at most 0.5 wt % are silanol radicals,
wherein a is 0, 1 or 2, where the indices a on both sides of the group Y may adopt their definition independently of one another, and so different a independently of one another may have different values within the specified value range,
wherein b is a number with a value of 1 to 11, preferably 1,
wherein c has a value of 0 to 0.9,
wherein d has a value of 0 to 0.8,
wherein e has a value of 0 to 0.5,
wherein f has a value of 0.01 to 0.6,
wherein g has a value of 0 to 0.6,
wherein h and j independently of one another are 0, 1 or 2,
wherein i is an integer with a value of 0 to 50,
wherein k has a value of 0 to 0.9,
wherein c+d+e+f+g+k=1, at least one value c, d or k is >0 and e+g is ≤0.6, and
wherein the radicals R, R¹, R², R³, R⁴ and R⁵ and the indices a, b, c, d, e, f, g, h and i in formula (I) and in formula (II) independently of one another may have the same definitions and may adopt these definitions independently of one another within the value ranges described;
reacting with water, in a first step, silanes of the formula (III)
R⁶ₗSiR⁷₄₋ₗ (III),
wherein R⁷ is a hydrolysable group,
wherein l is an integer with a value of 0, 1 or 2,
wherein R⁶ if l=1 is a radical R¹ and if l=2 is a radical R² and/or di-, oligo- or polysilanes of the formula (IV)
R⁷₃₋ₕR⁴ₕSi(SiR⁵₂)ᵢSiR⁴ⱼR⁷₃₋ⱼ (IV),
wherein R⁷ as above is a hydrolysable group and R⁴, R⁵, h, i and j have the same definitions as stated above, and/or
organyl-bridged silicones of the formula (V)
R⁷₃₋ₐRₐSiY(SiRₐR⁷₃₋ₐ)_{b} (V),
where R⁷, R, Y, a and b have the definition already stated; and
wherein at least one of the hydrolysable radicals R is not a halogen radical, using catalytic amounts of one or more acids which promote the hydrolysis and condensation of the components of formulae (III), (IV) and (V), in the presence of a non-water-miscible, aprotic solvent;
wherein after reaction has taken place, both the water and the remaining amount of acid in the organic phase are reduced to less than 10 000 ppm each; and
wherein in a second step reacting the reaction product from the first step, in solution in the inert organic solvent, without water, with a halosilane of the formula (VI)
R³₃SiR⁸ (VI),
wherein R³ has the same definitions as indicated above and R⁸ is a halogen atom, in the presence of an auxiliary base.

10. The process of claim 9, wherein the radicals R, R¹, R², R³, R⁴ and R⁵ are selected from methyl, phenyl, vinyl, acryloyloxy and methacryloyloxy radicals and also the acrylic esters or methacrylic esters of unbranched or branched alcohols having 1 to 15 carbon atoms.

11. The process of claim 9, wherein the aprotic solvent is an aromatic hydrocarbon.

12. The process of claim 9, wherein the auxiliary base is used in at least equimolar amount relative to the halosilane.

13. The process of claim 9, wherein the auxiliary base is selected from basic metal salts and nitrogen compounds.

14. The process of claim 9, wherein the polyorganosiloxanes of the formula (I) in a third step are joined to a metal substrate.

15. The process of claim 14, wherein the polyorganosiloxanes of the formula (I) in a fourth step are crosslinked.

16. The process of claim 14, wherein in the second step the halosilane of the formula (VI) is used so that the amount of halide radicals present is equimolar to the silanol radicals in the polyorganosiloxane species from the first reaction step.

17. The process of claim 9, wherein the polyorganosiloxanes are metal-clad laminates.
